(19) United States
(12) Patent Application Publication
(10) Pub. No.: US 2026/0266248 A1
(43) Pub. Date: Sep. 10, 2026

(54) FUEL-BASED HEATING TO ENABLE MIXING CONTROLLED COMBUSTION OF SMALL- MOLECULE FUELS

(71) Applicant: Climate Energy Investments, LLC, Los Altos, CA (US)

(72) Inventors: Peter V. WOON, Columbus, IN (US); Guanyu Frank ZHENG, Palatine, IL (US); Julie BLUMREITER, Batavia, IL (US); Robert SCHANZ, Aurora, IL (US); Manohar VITTAL, Naperville, IL (US); Jeremy BABINET, Geneva, IL (US); Craig BARNES, Columbus, IN (US); Jim CLERC, Columbus, IN (US); Greg HENDERSON, Columbus, IN (US)

(21) Appl. No.: 19/354,248

(22) Filed: Oct. 9, 2025

Related U.S. Application Data
(63) Continuation of application No. 19/061,622, filed on Feb. 24, 2025, now abandoned.
Application No. 19/061,622 is a continuation of application No. PCT/US2023/072843, filed on Aug. 24, 2023.
(60) Provisional application No. 63/400,702, filed on Aug. 24, 2022.

(51) Int. Cl. F02M 31/04; F02M 26/01; F02M 31/125; F02M 31/16; F02M 31/18; F02M 37/00

(52) U.S. Cl. CPC F02M 31/042; F02M 26/01; F02M 31/125; F02M 31/163; F02M 31/183; F02M 37/0064; F02M 2200/956

(57) ABSTRACT

Embodiments described herein relate to fuel-based heating of intake charge in internal combustion engines. In some aspects, a method of operating a compression ignition engine can include combusting a first fuel in an intake flow path to heat a volume of air. The method further includes drawing the heated volume of air into a plurality of cylinders via an intake manifold and combusting a volume of a second fuel in the plurality of cylinders in a mixing-controlled compression ignition mode (MCCI). The second fuel can be the same or different from the first fuel and can include a small-molecule fuel. Heating the volume of air maintains a temperature in the plurality of cylinders greater than a threshold temperature.

### CROSS REFERENCE TO RELATED APPLICATIONS

This application is a continuation of U.S. application Ser. No. 19/061,622, filed Feb. 24, 2025, which is a continuation of International Application No. PCT/US2023/072843, filed Aug. 24, 2023, which claims priority to and the benefit of U.S. Provisional Patent Application No. 63/400,702 entitled, “Fuel-Based Heating to Enable Mixing-Controlled Combustion of Small-Molecule Fuels” filed Aug. 24, 2022, the disclosures of each of which are incorporated herein by reference in their entireties.

### TECHNICAL FIELD

Embodiments described herein relate to systems and methods for fuel-based heating of internal combustion engines to enable combustion of small-molecule fuels.

### BACKGROUND

Burning ethanol, methanol, and other low cetane, small-molecule fuels in a mixing-controlled compression ignition (MCCI) engine requires significantly higher temperature to start combustion than diesel and other readily igniting traditional MCCI fuels. The most significant difficulty is providing enough heat at the end of compression in the engine to achieve ignition. Achieving ignition is particularly difficult in a cold environment. One method to achieve sufficiently high combustion temperatures is to increase the temperature of the incoming gases. Incoming gases are typically air and/or recirculated exhaust and are collectively referred to as ‘charge’-those gases which are brought in during the engine's intake stroke. This method achieves sufficiently high combustion temperatures by managing in-cylinder temperatures at intake valve closing.

### SUMMARY

Embodiments described herein relate to fuel-based heating of intake charge in internal combustion engines. In some aspects, a method of operating a compression ignition engine can include combusting a first fuel in an intake flow path to heat a volume of air. The method further includes drawing the heated volume of air into a plurality of cylinders via an intake manifold and combusting a volume of a second fuel in the plurality of cylinders in a mixing-controlled compression ignition mode (MCCI). The second fuel can be the same or different from the first fuel and can include a small-molecule fuel. Heating the volume of air maintains a temperature in the plurality of cylinders greater than a threshold temperature. In some embodiments, heating the volume of air can include feeding the first fuel from outside the intake flow path to inside the intake flow path via a fuel line, incorporating baffles or structures to support air entrainment with the fuel stream, and igniting the first fuel via an igniter.

### BRIEF DESCRIPTION OF THE DRAWINGS

FIG. 1 is a block diagram of a compression ignition engine for combustion of small-molecule fuel, according to an embodiment.

FIG. 2 is a flow diagram of a method for combustion of small-molecule fuel, according to an embodiment.

FIG. 3 is an illustration of an intake manifold with heaters, according to an embodiment.

FIG. 4 is an illustration of a structure for heating of intake charge gases, according to an embodiment.

FIG. 5 is an illustration of an intake heater disposed in an intake flow path, according to an embodiment.

FIG. 6 is an illustration of an intake heater disposed in an intake flow path, according to an embodiment.

FIG. 7 is an illustration of an intake heater disposed in an intake flow path, according to an embodiment.

FIG. 8 is an illustration of an intake heater disposed in an intake flow path, according to an embodiment.

FIG. 9 is an illustration of an intake heater disposed in an intake flow path, according to an embodiment.

FIGS. 10A-10D are illustrations of a small-molecule liquid fuel burner system, according to an embodiment.

FIG. 11 is an illustration of an intake heater disposed in an intake flow path, according to an embodiment.

FIG. 12 is an illustration of a fuel metering pump, according to an embodiment.

FIG. 13 is an illustration of an intake heater disposed in an intake flow path, according to an embodiment.

FIGS. 14A-14D are illustrations of intake heater locations in an intake flow path, according to various embodiments.

FIGS. 15A-15B are photographs of exterior views of intake heaters disposed in an intake flow path, according to an embodiment.

FIGS. 16A-16B show cross sections of flame protectors, according to various embodiments.

FIGS. 17A-17B show a blade configuration of a mixer, according to an embodiment.

FIG. 18 is an illustration of an intake heater disposed in an intake flow path, according to an embodiment.

### DETAILED DESCRIPTION

Embodiments described herein relate to combusting small-molecule fuels in compression ignition engines. Embodiments described herein also include applications of flame plugs for use with small molecule fuels for use as fuel-based heaters. Additionally, methods of extracting fuel energy for intake heat via a catalytic burner are described herein. Catalytic burners can employ an electric heater, a fuel doser, and/or a catalyst to raise the air temperature. The electric heater can be used to raise temperature to a catalyst activation temperature, beyond which fuel can be dosed upstream of the catalyst to generate catalytic combustion as the mixture passes through the heated catalyst.

Fuel combustion mechanisms described herein can include the use of flame plugs for heating of intake air (or other intake gases) and/or fuel nozzles with spark plugs. Flame protectors can be installed upstream of the flame plug and/or fuel nozzles to achieve: (1) stable ignition and combustion for extended heating; (2) acceptable pressure loss to engine intake assembly; (3) high temperature and velocity uniformity at engine intake ports; and (4) system robustness or failsafe operation in case one or more units fail.

Embodiments described herein include flame plugs for combustion of small molecule fuel as well as methods of extending the utility and longevity of such devices. Specifically, the use of one or more flame plugs on the intake manifold and intake piping of a compression ignition engine can dramatically increase the heat output of the devices. Additionally, modulating small-molecule fuel supply pressures to the flame plugs can vary the heat output of the devices. Also, modulating electrical input to the flame plug electrical heating elements according to air and fuel flow can account for additional heat of vaporization of the small-molecule fuel (e.g., a liquid fuel). Modifications to electrical input can also aid in cooling the tip of the flame plug via incoming air flow. Temperature sensing downstream of the flame plugs can be used to detect the presence of a flame.

Several geometrical layouts of fuel are described herein, including symmetrically mounted plug layouts and group mounted plug layouts. Multiple geometrical layouts of ignition mechanisms are described herein to achieve successful ignition and ensuing stable combustion. Burner designs for combustion of small molecule fuels are described herein. Some embodiments described herein relate to burners that can start rapidly and burn efficiently within the intake flow path of an engine. Some embodiments described herein relate to effective heating mechanisms to achieve scalable and stable heating power to an intake manifold (i.e., from system level considerations). Some embodiments described herein can minimize packaging size (i.e., the amount of space under the hood or in the engine enclosure space for execution of each of the heating implements) and pressure loss in engines.

In some embodiments, modular designs of an engine can be developed independent of installation space, orientation, engine type, number of cylinders, engine geometry (inline or V-shape) and power ranges. Some embodiments described herein include compact components that can fit in most engine compartment sizes. Some embodiments described herein can mitigate fuel deposits or clog buildup from additives in fuel feeding units under normal charge air temperature conditions (i.e., at temperatures between about 30° C. and about 200° C.). Some embodiments include heating solutions for the intake manifold. In a heating unit external to the combustion chamber, a flame protector, a fuel feeding unit, an igniter, and a mixer can be combined for solutions to engine heating problems. An external heating unit can include an electric heater and fuel dosing with a catalytic burner for engine heating. The functionalities of each unit can be integrated into the assembly.

Embodiments described herein can include wall mount layouts of flame plugs, concentric mounting of injectors with swirls or porous mixing structures, combinations of igniters and fuel feeding units as integrated burner units, an injector housing for ethanol combustion and migration of fuel deposit buildup, a combination of a flame protector and mixer for combustion, methods of controlling an ethanol purge for migration and prevention of deposit buildup, and packaging designs upstream of the engine intake manifold.

Embodiments described herein relate to various engine architectures, and are not limited to the four-stroke architecture most commonly used in on-road applications. The routing of air and fuel and adjusted thermal management can be applied to two-stroke, four-stroke, six-stroke, opposed piston, free piston, over-expanded (Atkinson or other) and/or rotary (Wankel or other) engine types.

One mechanism of heating intake air can include converting electricity into heat. Among applications of this mechanism, cartridge electric heaters can be placed in the intake air passages of engines. However, small-molecule fuel MCCI engines often require a larger amount of heat energy to ignite than more conventional fuels. These requirements can exceed the capability of the vehicle's battery and alternator, particularly during cold start scenarios. Similar methods of electric heating can be achieved via positive temperature coefficient (PTC) elements. However, despite their compact packaging and high power density, the heating power required during cold start often exceeds the battery power capacity. Heating of the charge can be done via a glow plug. However, such heat is also limited due to power capacity and/or the ability of the alternator to keep up with the electrical load of the heater.

Another mechanism of heating the intake charge moving through the intake flow path can include fuel combustion, though the applications of such mechanisms are limited due to combustion complexity and control. Such a method can be more effective than generating heating power than electrical mechanisms, as the combustion heat of diesel fuel, methanol, and ethanol are each in the range of 20,000 to 43,500 kJ/kg. Releasing a small dose of fuel can be sufficient to heat the intake charge for most cold start conditions.

Among fuel combustion applications, flame plugs can be used on diesel fueled engines. Flame plugs can integrate a fuel feeding unit and a glow plug together as a single piece which enables an air and fuel mixture to ignite at the vicinity of the tip of the glow plug, releasing combustion heat into the surrounding air. Such devices have thus far not been used with small-molecule fuels.

A more direct combustion method can include an independent diffusion burner which encompasses an igniter and a fuel injector. Such a method can also include utilizing compressed air and a flow distributor for heated charge transport to cylinders. Such methods can release heat directly to intake port via an additional manifold, which may be a standalone unit in addition to the engine intake manifold. Diffusion burning of small-molecule low-cetane fuel is more difficult than with high-cetane fuels, which have a much lower flammability limit. Autoignition temperatures for small-molecule low-cetane fuels are about 350-460° C. vs. approximately 210° C. for diesel fuel.

The primary challenges for electrical heating to increase the intake temperature on an internal combustion engine are packaging space for the heating elements, transmission of power to the heating elements, placement of the heat source close enough to the intake ports to reduce heat transfer to the walls after heating the intake charge and providing sufficient electrical power.

In some cases, small-molecule low-cetane fuel can be ignited more easily by increasing the air temperature from cold ambient conditions to a sufficient intake valve closure (IVC) temperature to maintain the engine at idle jut after the engine starts and before the engine has reached operating temperature. In an example case, ethanol can be ignited on a −25° C. day by heating the intake air to 150° C. at 900 rpm on a 15 L engine. The power requirement for such a heating strategy is about 15 kW. Considering that only about 60% of the added energy gets to the combustion chamber due to heat loss, a more realistic heat requirement of about 25 kW is practical. This is approximately 85,000 BTU/hr. This is approximately equal to the heat output of a typical residential furnace or about 16 portable electric heaters (1,500 W each). Current draw on a 12 V battery would be approximately 2,000 amps, which is much more than a typical engine starter motor.

Embodiments described herein include the use of high-power electric heaters, closely coupled to the intake ports to reduce heat transfer opportunities and quickly start the engine. Embodiments described herein have been developed with the recognition that extended operation of electric heaters is beyond practical battery reserve capacity and engine-mounted alternator current capacity.

Fuel-based heating can be more practical at the aforementioned 15 kW heating scenario. One liter of ethanol can provide 25 kW of heat addition for approximately 15 minutes, which is sufficient to increase the engine's temperature up to the operating temperature.

There are several challenges associated with the use of fuel-based burners. First, the ignition of the fuel may be difficult to control. The initial heat generated needs to overcome the activation energy of the combustion and, in the case of diffusion burners, the heat of vaporization of liquid fuels. The location of ignition is highly dependent on the fuel and air mixture patten, which are highly transient and localized during burner startup. Second, once ignition starts, combustion stability is difficult to maintain. Due to individual cylinder piston displacement, the engine can generate a pulsating flow pattern, which adds oscillation to velocity and flow properties, making combustion unstable. Additionally, geometrically generated flow patterns such as flow separations often disrupt smooth running of combustion. Transient conditions and high flow rate conditions both drastically disrupt the energy balance between fuel combustion and heat loss. Third, thermal management is difficult for burner systems because the flame temperature of most fuels in air are around 2,200 K while the target temperature distribution at intake ports is only about 150° C. or 425 K. Given the short mixing length between the combustion core and ports, distribution of heat and mass flow evenly across all ports and inside each port is difficult. Fuel-based heaters may also use some of the oxygen in the engine intake system and this may hinder combustion. Some burner systems may bring in supplemental air or oxygen to allay this concern.

Fuel-based burners can include external heating sources. Both diffusion flame burners and premixed burners are described herein. In some embodiments, ignition can be achieved by glow plug, spark plug, and/or a hot surface igniter. For example, a diffusion flame burner is a burner, in which a fuel is introduced as a primary fuel, typically in liquid form. The fuel can burn around a periphery of the concentrated fuel near the interface of the fuel with air. The fuel can burn in a region that is substantially stoichiometric. A candle is an example of a diffusion flame, and an oil furnace or jet engine combustor are further examples of diffusion flame combustion.

Examples of thermal management systems used in compression ignition engines can be found in U.S. Pat. No. 9,903,262 (“the '262 patent”), filed Apr. 6, 2015, entitled “STOICHIOMETRIC C HIGH-TEMPERATURE DIRECT-INJECTION COMPRESSION-IGNITION ENGINE,” International Patent Application No. PCT/US2020/032961 (“the '961 application”), filed May 14, 2020, entitled “COLD START FOR HIGH-OCTANE FUELS IN A DIESEL ENGINE ARCHITECTURE,” U.S. Pat. No. 11,428,186 (“the '186 patent”), filed Sep. 16, 2021, entitled “FUEL AGNOSTIC COMPRESSION IGNITION ENGINE,” U.S. Patent Publication No. 2022/0018297 (“the '297 publication”), filed Sep. 30, 2021 and titled “SYSTEMS AND METHODS OF CYLINDER DEACTIVATION IN HIGH-TEMPERATURE MIXING-CONTROLLED ENGINES,” and U.S. Provisional Patent Application No. 63/400,702 (“the '702 application”), filed Aug. 24, 2022 and titled “FUEL-BASED HEATING TO ENABLE MIXING-CONTROLLED COMBUSTION OF SMALL MOLECULE FUELS,” the disclosures of which are hereby incorporated by reference in their entireties.

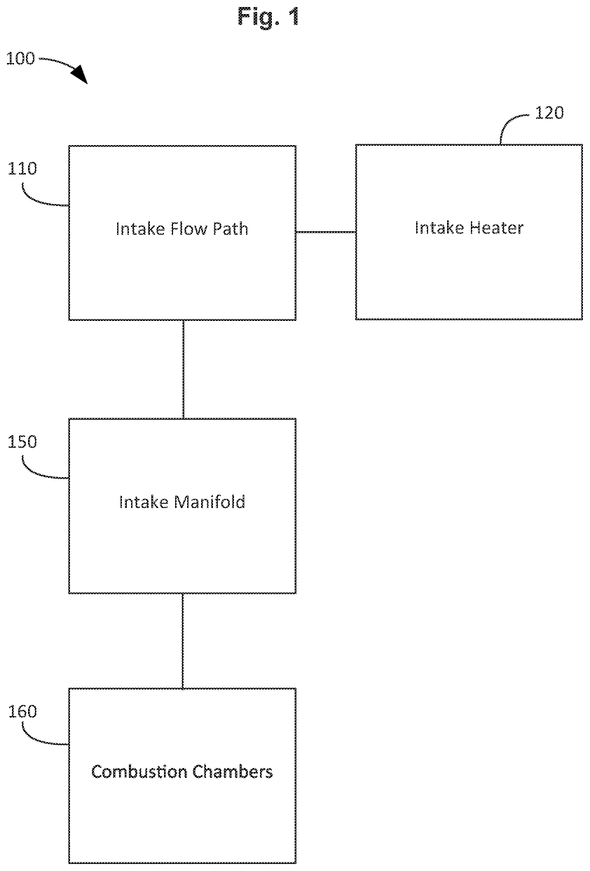

FIG. 1 is a block diagram of a system 100 for combustion of small-molecule fuel, according to an embodiment. The system 100 can be integrated into a compression ignition engine. As shown, the system 100 includes an intake flow path 110 with an intake heater 120. The intake flow path 110 is fluidically coupled to an intake manifold 150 and combustion chambers 160. During operation, a volume of intake gas (e.g., air) flows through the intake flow path 110 and is heated via the intake heater 120. The volume of intake gas then flows into the combustion chambers 160 via the intake manifold 150. Fuel is then combusted with the intake gas in the combustion chambers 160.

The intake flow path 110 is a conduit for movement of intake gas into the combustion chambers 160 (via the intake manifold 150). In some embodiments, the intake flow path 110 can have a circular cross section. In some embodiments, the intake flow path 110 can have an elliptical cross section. In some embodiments, the intake flow path 110 can follow a circuitous path to the intake manifold 150. In some embodiments, the intake flow path 110 can include pipes. In some embodiments, the intake flow path 110 can include tubing. In some embodiments, the intake flow path 110 can be composed of a metal. In some embodiments, the intake flow path 110 can be composed of cast iron, steel, stainless steel, aluminum, or any combination thereof.

In some embodiments, the intake flow path 110 can have an inner diameter of at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, or at least about 90 cm. In some embodiments, the intake flow path 110 can have an inner diameter of no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, or no more than about 2 cm. Combinations of the above-referenced inner diameters are also possible (e.g., at least about 1 cm and no more than about 1 m or at least about 5 cm and no more than about 25 cm), inclusive of all values and ranges therebetween. In some embodiments, the intake flow path 110 can have an inner diameter of about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, or about 1 m.

In some embodiments, the intake gas can include air. In some embodiments, the intake gas can include ambient air. In some embodiments, the intake gas can have an oxygen content of at least about 5 vol %, at least about 10 vol %, at least about 15 vol %, at least about 20 vol %, at least about 25 vol %, at least about 30 vol %, at least about 35 vol %, at least about 40 vol %, or at least about 45 vol %. In some embodiments, the intake gas can have an oxygen content of no more than about 50 vol %, no more than about 45 vol %, no more than about 40 vol %, no more than about 35 vol %, no more than about 30 vol %, no more than about 25 vol %, no more than about 20 vol %, no more than about 15 vol %, or no more than about 10 vol %. Combinations of the above-referenced oxygen contents are also possible (e.g., at least about 5 vol % and no more than about 50 vol % or at least about 20 vol % and no more than about 30 vol %), inclusive of all values and ranges therebetween. In some embodiments, the intake gas can have an oxygen content of about 5 vol %, about 10 vol %, about 15 vol %, about 20 vol %, about 25 vol %, about 30 vol %, about 35 vol %, about 40 vol %, about 45 vol %, or about 50 vol %.

The intake heater 120 heats the intake gas as the intake gas moves through the intake flow path 110. In some embodiments, the intake heater 120 can include a burner (i.e., the intake heater 120 can produce a flame). In some embodiments, the intake heater 120 can include a flame plug. In some embodiments, the intake heater 120 can receive a fuel for combustion and the waste heat from the combustion can be used to heat the intake gas in the intake flow path 110. In some embodiments, the fuel can be pre-heated before it enters the intake heater 120. In some embodiments, the fuel can be stored in a heated tank before entering the intake heater 120.

The intake manifold 150 feeds the intake gas from the intake flow path 110 to the combustion chambers 160. The intake manifold 150 splits the intake flow path 110 into multiple streams that enter multiple combustion chambers 160. In some embodiments, the intake manifold 150 can be composed of the same material as the intake flow path 110. In some embodiments, the intake manifold 150 can be composed of a different material from the intake flow path 110.

The combustion chambers 160 are volumes, in which combustion occurs. In some embodiments, the combustion chambers 160 can include cylinders. In some embodiments, the combustion chambers 160 can each include intake valves, exhaust valves, fuel injectors, pistons, and head decks. In some embodiments, the system 100 can include about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, or about 32 combustion chambers 160, inclusive of all values and ranges therebetween.

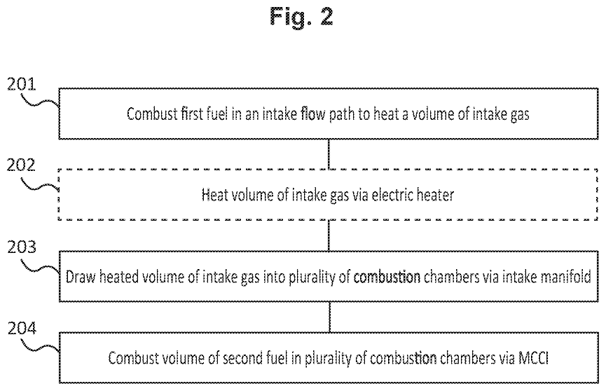

FIG. 2 is a flow diagram of a method 200 for combustion of small-molecule fuel, according to an embodiment. As shown, the method 200 includes combusting a first fuel in an intake flow path to heat a volume of intake gas at step 201. The method 200 optionally includes heating the volume of intake gas via an electric heater at step 202. The method 200 further includes drawing a heated volume of the intake gas into a plurality of combustion chambers via an intake manifold at step 203 and combusting a volume of a second fuel in the plurality of combustion chambers via MCCI at step 204.

Step 201 includes combusting the first fuel in an intake flow path to heat the volume of intake gas. In some embodiments, the first fuel can include a small molecule fuel. In some embodiments, the first fuel can have a cetane number of at least about −10, at least about −5, at least about 0, at least about 5, at least about 10, at least about 15, at least about 20, at least about 25, at least about 30, or at least about 35. In some embodiments, the first fuel can have a cetane number of no more than about 40, no more than about 35, no more than about 30, no more than about 25, no more than about 20, no more than about 15, no more than about 10, no more than about 5, no more than about 0, or no more than about −5. Combinations of the above-referenced cetane numbers of the first fuel are also possible (e.g., at least about −10 and no more than about 40 or at least about 10 and no more than about 20), inclusive of all values and ranges therebetween. In some embodiments, the first fuel can have a cetane number of about −10, about −5, about 0, about 5, about 10, about 15, about 20, about 25, about 30, about 35, or about 40.

In some embodiments, the first fuel can have a flash point of at least about 0° C., at least about 5° C., at least about 10° C., at least about 15° C., at least about 20° C., at least about 25° C., at least about 30° C., at least about 35° C., at least about 40° C., or at least about 45° C. In some embodiments, the first fuel can have a flash point of no more than about 50° C., no more than about 45° C., no more than about 40° C., no more than about 35° C., no more than about 30° C., no more than about 25° C., no more than about 20° C., no more than about 15° C., no more than about 10° C., or no more than about 5° C. Combinations of the above-referenced flash points of the first fuel are also possible (e.g., at least about 0° C. and no more than about 50° C. or at least about 10° C. and no more than about 40° C., inclusive of all values and ranges therebetween. In some embodiments, the first fuel can have a flash point of about 0° C., about 5° C., about 10° C., about 15° C., about 20° C., about 25° C., about 30° C., about 35° C., about 40° C., about 45° C., or about 50° C.

In some embodiments, the first fuel can include naphtha, gasoline, alcohol, butanol, propanol, ethanol, methanol, a gasoline/ethanol mixture, a gasoline/methanol mixture, methanol/ethanol mixture, a denatured alcohol, hydrous alcohol, gaseous hydrocarbons, natural gas, methane, ethane, propane, butane, hexane, alternative fuels, hydrogen, ammonia, syngas, and/or CO. In some embodiments, the first fuel can have a small amount of additives that result in a substantial change in cetane number. In some embodiments, the first fuel can include less than about 5,000 ppm, less than about 4,000 ppm, less than about 3,000 ppm, less than about 2,000 ppm, less than about 1,000 ppm, less than about 900 ppm, less than about 800 ppm, less than about 700 ppm, less than about 600 ppm, or less than about 500 ppm by weight of additives that result in a substantial change in cetane number. In some embodiments, the first fuel can be substantially free of additives that result in a substantial change in cetane number.

In some embodiments, the first fuel can have an octane number (i.e., calculated via (RON+MON)/2 method) of at least about 50, at least about 55, at least about 60, at least about 65, at least about 70, at least about 75, at least about 80, at least about 85, at least about 90, at least about 95, at least about 100, at least about 105, at least about 110, at least about 115, at least about 120, at least about 125, at least about 130, at least about 135, at least about 140, or at least about 145. In some embodiments, the first fuel can have an octane number of no more than about 150, no more than about 145, no more than about 140, no more than about 135, no more than about 130, no more than about 125, no more than about 120, no more than about 115, no more than about 110, no more than about 105, no more than about 100, no more than about 95, no more than about 90, no more than about 85, no more than about 80, no more than about 75, no more than about 70, no more than about 65, no more than about 60, or no more than about 55. Combinations of the above-referenced octane numbers are also possible (e.g., at least about 50 and no more than about 150 or at least about 80 and no more than about 120), inclusive of all values and ranges therebetween. In some embodiments, the first fuel can have an octane number of about 50, about 55, about 60, about 65, about 70, about 75, about 80, about 85, about 90, about 95, about 100, about 105, about 110, about 115, about 120, about 125, about 130, about 135, about 140, about 145, or about 150.

In some embodiments, the first fuel can include a fuel with 1 carbon atom per molecule (e.g., methane, methanol). In some embodiments, the first fuel can be free of carbon atoms (e.g., hydrogen). In some embodiments, the first fuel can include a fuel with at least about 1 carbon atom per molecule, at least about 2 carbon atoms per molecule, at least about 3 carbon atoms per molecule, at least about 4 carbon atoms per molecule, at least about 5 carbon atoms per molecule, at least about 6 carbon atoms per molecule, at least about 7 carbon atoms per molecule, at least about 8 carbon atoms per molecule, or at least about 9 carbon atoms per molecule. In some embodiments, the first fuel can include a fuel with no more than about 10 carbon atoms per molecule, no more than about 9 carbon atoms per molecule, no more than about 8 carbon atoms per molecule, no more than about 7 carbon atoms per molecule, no more than about 6 carbon atoms per molecule, no more than about 5 carbon atoms per molecule, no more than about 4 carbon atoms per molecule, no more than about 3 carbon atoms per molecule, or no more than about 2 carbon atoms per molecule. Combinations of the above-referenced numbers of carbon atoms per molecule are also possible (e.g., at least about 1 carbon atom per molecule and no more than about 10 carbon atoms per molecule or at least about 1 carbon atom per molecule and no more than about 3 carbon atoms per molecule), inclusive of all values and ranges therebetween. In some embodiments, the first fuel can include a fuel with about 1 carbon atom per molecule, about 2 carbon atoms per molecule, about 3 carbon atoms per molecule, about 4 carbon atoms per molecule, about 5 carbon atoms per molecule, about 6 carbon atoms per molecule, about 7 carbon atoms per molecule, about 8 carbon atoms per molecule, about 9 carbon atoms per molecule, or about 10 carbon atoms per molecule.

In some embodiments, the first fuel can include water (i.e., the first fuel can be hydrous). In some embodiments, the first fuel can include at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, or at least about 14 wt % water. In some embodiments, the first fuel can include no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, or no more than about 0.2 wt % water. Combinations of the above-referenced water percentages are also possible (e.g., at least about 0.1 wt % and no more than about 15 wt % or at least about 0.5 wt % and no more than about 10 wt %), inclusive of all values and ranges therebetween. In some embodiments, the first fuel can include about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt % water.

In some embodiments, the first fuel can be the same fuel as the second fuel (i.e., the fuel combusted in the combustion chambers at step 204). In some embodiments, the first fuel can be a different fuel from the second fuel. In some embodiments, the first fuel can include a high cetane fuel. In some embodiments, the first fuel can include a fuel with a cetane number of at least about 35, at least about 40, at least about 45, at least about 50, at least about 55, at least about 60, at least about 65, at least about 70, at least about 75, at least about 80, at least about 85, at least about 90, at least about 95, or at least about 100, inclusive of all values and ranges therebetween. In some embodiments, the first fuel can include diesel fuel, gasoline, biodiesel, dimethyl ether, or any combination thereof.

In some embodiments, the combustion of the first fuel can occur at least partially inside a flame plug. In some embodiments, the flame plug can include a glow plug disposed therein. A flame plug can act as an integrated fuel feeding unit, igniter, and burner. Flame plugs can include a heating element encased in a body and a tip/burner region is exposed to the inflow of the intake gas. The first fuel enters the flame plug and is routed past the heating element annularly to preheat the first fuel and begin to gasify the first fuel. The first fuel can reach a red-hot end of an electrical heater inside the flame plug, and the fuel ignites in the oxygen rich region of the tip of the glow plug disposed in the flame plug. Flame plugs can work well with diesel fuel, but more electrical heat is generally needed when combusting small-molecule liquid fuels in flame plugs, in order to account for the high heat of vaporization. Additionally, less heat is released for the same mass of small-molecule liquid fuel (as compared to diesel), so higher fuel flow rates or more flame plugs should be used for small-molecule liquid fuel engines.

In some embodiments, the first fuel can be fed to the flame plug from a location external to the intake flow path (e.g., via a tube that flows fuel to a fuel injector installed in a wall of the intake flow path). In some embodiments, the first fuel can be fed to the flame plug in a steady stream. In some embodiments, the first fuel can be fed to the intake flow path (e.g., to the flame plug) at a rate of at least about 1 mg/s, at least about 2 mg/s, at least about 3 mg/s, at least about 4 mg/s, at least about 5 mg/s, at least about 6 mg/s, at least about 7 mg/s, at least about 8 mg/s, at least about 9 mg/s, at least about 10 mg/s, at least about 20 mg/s, at least about 30 mg/s, at least about 40 mg/s, at least about 50 mg/s, at least about 60 mg/s, at least about 70 mg/s, at least about 80 mg/s, at least about 90 mg/s, at least about 100 mg/s, at least about 200 mg/s, at least about 300 mg/s, at least about 400 mg/s, at least about 500 mg/s, at least about 600 mg/s, at least about 700 mg/s, at least about 800 mg/s, at least about 900 mg/s, at least about 1 g/s, at least about 2 g/s, at least about 3 g/s, at least about 4 g/s, at least about 5 g/s, at least about 6 g/s, at least about 7 g/s, at least about 8 g/s, at least about 9 g/s, at least about 10 g/s, at least about 11 g/s, at least about 12 g/s, at least about 13 g/s, at least about 14 g/s, at least about 15 g/s, at least about 16 g/s, at least about 17 g/s, at least about 18 g/s, or at least about 19 g/s. In some embodiments, the first fuel can be fed to the intake flow path at a rate of no more than about 20 g/s, no more than about 19 g/s, no more than about 18 g/s, no more than about 17 g/s, no more than about 16 g/s, no more than about 15 g/s, no more than about 14 g/s, no more than about 13 g/s, no more than about 12 g/s, no more than about 11 g/s, no more than about 10 g/s, no more than about 9 g/s, no more than about 8 g/s, no more than about 7 g/s, no more than about 6 g/s, no more than about 5 g/s, no more than about 4 g/s, no more than about 3 g/s, no more than about 2 g/s, no more than about 1 g/s, no more than about 900 mg/s, no more than about 800 mg/s, no more than about 700 mg/s, no more than about 600 mg/s, no more than about 500 mg/s, no more than about 400 mg/s, no more than about 300 mg/s, no more than about 200 mg/s, no more than about 100 mg/s, no more than about 90 mg/s, no more than about 80 mg/s, no more than about 70 mg/s, no more than about 60 mg/s, no more than about 50 mg/s, no more than about 40 mg/s, no more than about 30 mg/s, no more than about 20 mg/s, no more than about 10 mg/s, no more than about 9 mg/s, no more than about 8 mg/s, no more than about 7 mg/s, no more than about 6 mg/s, no more than about 5 mg/s, no more than about 4 mg/s, no more than about 3 mg/s, or no more than about 2 mg/s. Combinations of the above-referenced feed rates are also possible (e.g., at least about 1 mg/s and no more than about 20 g/s or at least about 10 mg/s and no more than about 100 mg/s), inclusive of all values and ranges therebetween. In some embodiments, the first fuel can be fed to the flame plug in a steady stream. In some embodiments, the first fuel can be fed to the intake flow path at a rate of about 1 mg/s, about 2 mg/s, about 3 mg/s, about 4 mg/s, about 5 mg/s, about 6 mg/s, about 7 mg/s, about 8 mg/s, about 9 mg/s, about 10 mg/s, about 20 mg/s, about 30 mg/s, about 40 mg/s, about 50 mg/s, about 60 mg/s, about 70 mg/s, about 80 mg/s, about 90 mg/s, about 100 mg/s, about 200 mg/s, about 300 mg/s, about 400 mg/s, about 500 mg/s, about 600 mg/s, about 700 mg/s, about 800 mg/s, about 900 mg/s, about 1 g/s, about 2 g/s, about 3 g/s, about 4 g/s, about 5 g/s, about 6 g/s, about 7 g/s, about 8 g/s, about 9 g/s, about 10 g/s, about 11 g/s, about 12 g/s, about 13 g/s, about 14 g/s, about 15 g/s, about 16 g/s, about 17 g/s, about 18 g/s, about 19 g/s, or about 20 g/s.

Step 202 is optional and includes heating the volume of intake gas via an electric heater. An electric heater can provide supplemental heat to the intake gas as the intake gas moves through the intake flow path. In some embodiments, the electric heater can be disposed around an outside diameter or outside surface of the intake flow path. In some embodiments, the electric heater can include a heating tape. In some embodiments, the electric heater can include an electrically conductive wire. In some embodiments, the electrically conductive wire can be encased with an insulating layer (e.g., rubber). In some embodiments, the electric heater can include a blower that conveys warm air to contact the outside surface of the intake flow path.

Step 203 includes drawing a heated volume of intake gas into the plurality of combustion chambers via the intake manifold. In some embodiments, the movement of the intake gas into the plurality of combustion chambers can be induced via engine cranking. In some embodiments, the intake gas can be pressurized. In some embodiments, the intake gas can be pressurized via a supercharger, a turbocharger, and/or any other turbo compounding device.

Step 204 includes combusting a volume of a second fuel in the plurality of combustion chambers via MCCI. In some embodiments, the second fuel can be injected into the plurality of combustion chambers via fuel injectors disposed in the combustion chambers. In some embodiments, the second fuel can be injected into the plurality of combustion chambers via fuel injectors disposed in flow paths just outside of the combustion chambers (e.g., immediately upstream of the intake valves). In some embodiments, the second fuel can be the same or substantially similar to the first fuel. In some embodiments, the second fuel can be a different fuel from the first fuel.

In some embodiments, the second fuel can have a cetane number of at least about −10, at least about −5, at least about 0, at least about 5, at least about 10, at least about 15, at least about 20, at least about 25, at least about 30, or at least about 35. In some embodiments, the second fuel can have a cetane number of no more than about 40, no more than about 35, no more than about 30, no more than about 25, no more than about 20, no more than about 15, no more than about 10, no more than about 5, no more than about 0, or no more than about −5. Combinations of the above-referenced cetane numbers of the second fuel are also possible (e.g., at least about −10 and no more than about 40 or at least about 10 and no more than about 20), inclusive of all values and ranges therebetween. In some embodiments, the second fuel can have a cetane number of about −10, about −5, about 0, about 5, about 10, about 15, about 20, about 25, about 30, about 35, or about 40.

In some embodiments, the second fuel can have a flash point of at least about 0° C., at least about 5° C., at least about 10° C., at least about 15° C., at least about 20° C., at least about 25° C., at least about 30° C., at least about 35° C., at least about 40° C., or at least about 45° C. In some embodiments, the second fuel can have a flash point of no more than about 50° C., no more than about 45° C., no more than about 40° C., no more than about 35° C., no more than about 30° C., no more than about 25° C., no more than about 20° C., no more than about 15° C., no more than about 10° C., or no more than about 5° C. Combinations of the above-referenced flash points of the first fuel are also possible (e.g., at least about 0° C. and no more than about 50° C. or at least about 10° C. and no more than about 40° C., inclusive of all values and ranges therebetween. In some embodiments, the second fuel can have a flash point of about 0° C., about 5° C., about 10° C., about 15° C., about 20° C., about 25° C., about 30° C., about 35° C., about 40° C., about 45° C., or about 50° C.

In some embodiments, the second fuel can include naphtha, gasoline, alcohol, butanol, propanol, ethanol, methanol, a gasoline/ethanol mixture, a gasoline/methanol mixture, methanol/ethanol mixture, a denatured alcohol, hydrous alcohol, gaseous hydrocarbons, natural gas, methane, ethane, propane, butane, hexane, alternative fuels, hydrogen, ammonia, syngas, and/or CO. In some embodiments, the second fuel can have a small amount of additives that result in a substantial change in cetane number. In some embodiments, the second fuel can include less than about 5,000 ppm, less than about 4,000 ppm, less than about 3,000 ppm, less than about 2,000 ppm, less than about 1,000 ppm, less than about 900 ppm, less than about 800 ppm, less than about 700 ppm, less than about 600 ppm, or less than about 500 ppm by weight of additives that result in a substantial change in cetane number. In some embodiments, the second fuel can be substantially free of additives that result in a substantial change in cetane number.

In some embodiments, the second fuel can have an octane number (i.e., calculated via (RON+MON)/2 method) of at least about 50, at least about 55, at least about 60, at least about 65, at least about 70, at least about 75, at least about 80, at least about 85, at least about 90, at least about 95, at least about 100, at least about 105, at least about 110, at least about 115, at least about 120, at least about 125, at least about 130, at least about 135, at least about 140, or at least about 145. In some embodiments, the second fuel can have an octane number of no more than about 150, no more than about 145, no more than about 140, no more than about 135, no more than about 130, no more than about 125, no more than about 120, no more than about 115, no more than about 110, no more than about 105, no more than about 100, no more than about 95, no more than about 90, no more than about 85, no more than about 80, no more than about 75, no more than about 70, no more than about 65, no more than about 60, or no more than about 55. Combinations of the above-referenced octane numbers are also possible (e.g., at least about 50 and no more than about 150 or at least about 80 and no more than about 120), inclusive of all values and ranges therebetween. In some embodiments, the second fuel can have an octane number of about 50, about 55, about 60, about 65, about 70, about 75, about 80, about 85, about 90, about 95, about 100, about 105, about 110, about 115, about 120, about 125, about 130, about 135, about 140, about 145, or about 150.

In some embodiments, the second fuel can include a fuel with 1 carbon atom per molecule (e.g., methane, methanol). In some embodiments, the second fuel can be free of carbon atoms (e.g., hydrogen). In some embodiments, the second fuel can include a fuel with at least about 1 carbon atom per molecule, at least about 2 carbon atoms per molecule, at least about 3 carbon atoms per molecule, at least about 4 carbon atoms per molecule, at least about 5 carbon atoms per molecule, at least about 6 carbon atoms per molecule, at least about 7 carbon atoms per molecule, at least about 8 carbon atoms per molecule, or at least about 9 carbon atoms per molecule. In some embodiments, the second fuel can include a fuel with no more than about 10 carbon atoms per molecule, no more than about 9 carbon atoms per molecule, no more than about 8 carbon atoms per molecule, no more than about 7 carbon atoms per molecule, no more than about 6 carbon atoms per molecule, no more than about 5 carbon atoms per molecule, no more than about 4 carbon atoms per molecule, no more than about 3 carbon atoms per molecule, or no more than about 2 carbon atoms per molecule. Combinations of the above-referenced numbers of carbon atoms per molecule are also possible (e.g., at least about 1 carbon atom per molecule and no more than about 10 carbon atoms per molecule or at least about 1 carbon atom per molecule and no more than about 3 carbon atoms per molecule), inclusive of all values and ranges therebetween. In some embodiments, the second fuel can include a fuel with about 1 carbon atom per molecule, about 2 carbon atoms per molecule, about 3 carbon atoms per molecule, about 4 carbon atoms per molecule, about 5 carbon atoms per molecule, about 6 carbon atoms per molecule, about 7 carbon atoms per molecule, about 8 carbon atoms per molecule, about 9 carbon atoms per molecule, or about 10 carbon atoms per molecule.

In some embodiments, the second fuel can include water (i.e., the second fuel can be hydrous). In some embodiments, the second fuel can include at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, or at least about 14 wt % water. In some embodiments, the second fuel can include no more than about 15 wt %, no more than about 14 wt %, no more than about 13 wt %, no more than about 12 wt %, no more than about 11 wt %, no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, or no more than about 0.2 wt % water. Combinations of the above-referenced water percentages are also possible (e.g., at least about 0.1 wt % and no more than about 15 wt % or at least about 0.5 wt % and no more than about 10 wt %), inclusive of all values and ranges therebetween. In some embodiments, the second fuel can include about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt % water.

In some embodiments, less than 50% of the volume of the second fuel can be pre-mixed with the volume of intake gas upon initiation of combustion. In other words, the ignition of the volume of the second fuel can be mixing controlled, or MCCI. In some embodiments, at least about 5%, at least about 10%, at least about 15%, at least about 20%, at least about 25%, at least about 30%, at least about 35%, at least about 40%, or at least about 45% of the volume of the second fuel can be pre-mixed with the volume of intake gas upon initiation of combustion. In some embodiments, no more than about 50%, no more than about 45%, no more than about 40%, no more than about 35%, no more than about 30%, no more than about 25%, no more than about 20%, no more than about 15%, or no more than about 10% of the volume of the second fuel can be pre-mixed with the volume of the intake gas upon initiation of combustion. Combinations of the above-referenced percentages of the volume of the second fuel pre-mixed with the volume of the intake gas are also possible (e.g., at least about 5% and no more than about 50% or at least about 10% and no more than about 40%), inclusive of all values and ranges therebetween. In some embodiments, about 5%, about 10%, about 15%, about 20%, about 25%, about 30%, about 35%, about 40%, about 45%, or about 50% of the volume of the second fuel can be pre-mixed with the volume of the intake gas upon initiation of combustion. In some embodiments, the local equivalence ratio at points within the combustion chambers can be at least about 1.5, at least about 2, at least about 3, at least about 4, at least about 5, at least about 6, at least about 7, at least about 8, at least about 9, or at least about 10, inclusive of all values and ranges therebetween.

In some embodiments, at least about 25% of the energy generated from combustion of the volume of the second fuel can be generated while the volume of the second fuel is being injected into the combustion chambers. In some embodiments, at least about 30% of the energy generated from combustion of the volume of the second fuel can be generated while the volume of the second fuel is being injected into the combustion chambers. In some embodiments, at least about 35%, at least about 40%, at least about 45%, at least about 50%, at least about 55%, at least about 60%, at least about 65%, at least about 70%, at least about 75%, at least about 80%, at least about 85%, or at least about 90% of the energy generated from combustion of the volume of the second fuel can be generated while the volume of the second fuel is being injected into the combustion chambers. In some embodiments, no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, or no more than about 30% of the energy generated from combustion of the volume of the second fuel can be generated while the volume of the second fuel is being injected into the combustion chambers. Combinations of the above-referenced percentages of the energy generated from combustion of the volume of the second fuel can be generated while the volume of the second fuel is being injected into the combustion chamber (e.g., at least about 40% and no more than about 95% or at least about 60% and no more than about 80%), inclusive of all values and ranges therebetween. In some embodiments, about 25%, about 30%, about 35%, about 40%, about 45%, about 50%, about 55%, about 60%, about 65%, about 70%, about 75%, about 80%, about 85%, about 90%, or about 95% of the energy generated from combustion of the volume of the second fuel can be generated while the volume of the second fuel is being injected into the combustion chambers.

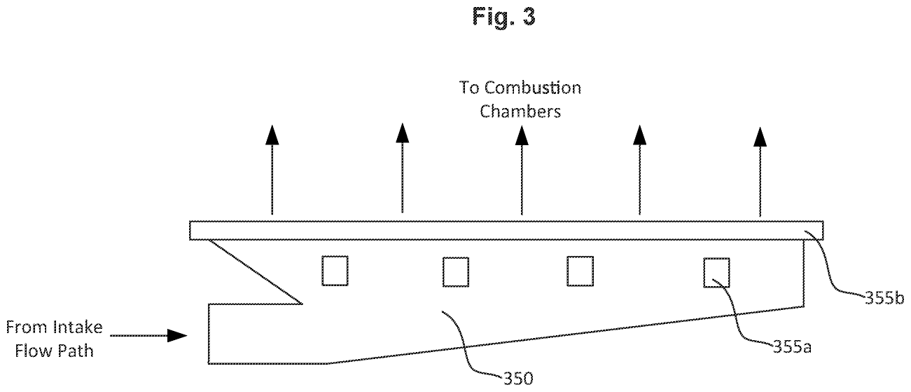

FIG. 3 is an illustration of an intake manifold 350 with intake heaters 355a, 355b (collectively referred to as intake heaters 355), according to an embodiment. As shown, the intake heaters 355a act as separate or disjointed heaters, while the heater 355b acts as a heater assembly. Intake gas flows into the intake manifold 350 and is heated via the heaters 355 and exits the intake manifold 350 as heated intake gas. The layout of the heaters 355 is particularly suited to the packaging constraints of electric heaters. By locating the heaters 355 as close to the cylinder head (not shown) and intake ports (not shown) as possible, more of the heat reaches the combustion chambers. In other words, the heat does not dissipate substantially before entering the combustion chambers. In addition, the air space just upstream of the combustion chambers can be preheated (e.g., via the heater 355b), so that the first intake gas the engine draws in upon cranking is at a temperature sufficient for combustion.

In some embodiments, the intake heaters 355 can be communicatively coupled to a control system for optimizing pre-heat time and current delivered to the intake heaters 355. The control system can also modulate current after engine cranks and run to meet engine combustion requirements while keeping the temperature of the intake heaters 355 below a maximum for adequate element life. In some embodiments, the electric voltage supplied to the heaters 355 can be about 3 V, about 6 V, about 9 V, about 12 V, about 15 V, about 18 V, about 21 V, about 24 V, about 27 V, about 30 V, about 33 V, about 36 V, about 39 V, about 42 V, about 45 V, about 48 V DC, or any voltage available on the vehicle or at the engine installation site, including 120-480 V AC. In some embodiments, the heaters 355a and/or the heater 355b can include a flame plug or other fuel-based heater. In other words, a flame plug or fuel-based heater can be disposed in the intake manifold 350.

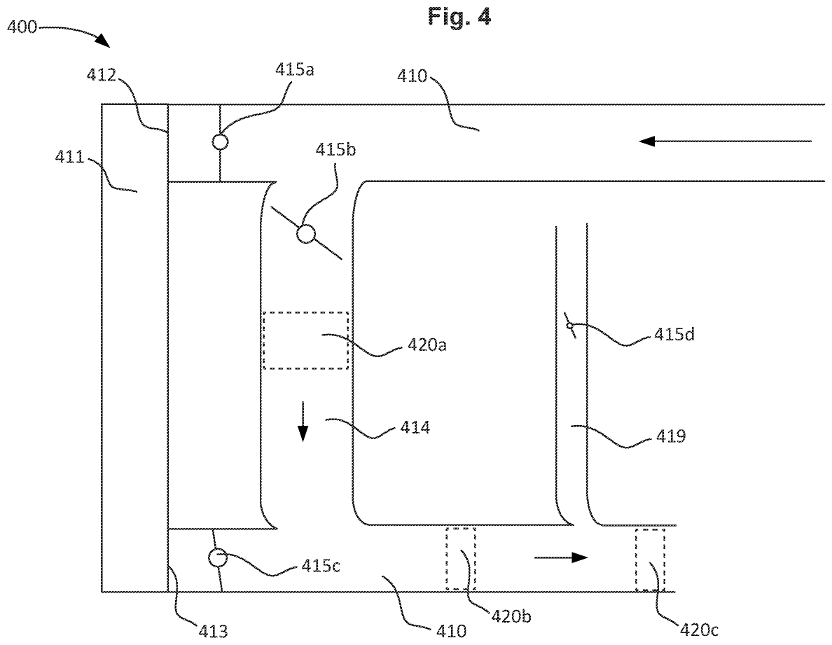

FIG. 4 is a schematic illustration of a system 400 for heating of intake charge gases, according to an embodiment. As shown, the system 400 includes an intake flow path 410, a charge air cooler (CAC) 411, a CAC inlet 412, a CAC outlet 413, a CAC bypass 414, valves 415a, 415b, 415c (collectively referred to as valves 415), an EGR cooler bypass 419, and intake heaters 420a, 420b, 420c (collectively referred to as intake heaters 420). In some embodiments, the intake flow path 410 and the intake heaters 420 can be the same or substantially similar to the intake flow path 110 and the heaters 120, as described above with reference to FIG. 1. Thus, certain aspects of the intake flow path 410 and the intake heaters 420 are not described in greater detail herein.

In use, a volume of intake gas moves through the intake flow path 410 and through one or more of the valves 415a, 415b. The valves 415a, 415b control the partitioning of the intake gas between the CAC 411 and the CAC bypass 414. After advancing further through the intake flow path 410, the intake gas moves into combustion chambers (not shown) via an intake manifold (not shown). Heated EGR gas from the EGR cooler bypass 419 can merge with the intake gas before the intake gas moves through the intake manifold and into the combustion chambers.

The CAC 411 is a heat exchanger that cools the intake gas as the intake gas enters the CAC 411. In some embodiments, the intake gas can enter the heat exchanger from a turbocharger, a supercharger, and/or any other turbo-compounding device. As shown, the CAC 411 includes an inlet 412 for the inflow of the intake gas and an outlet 413 for the outflow of the intake gas. In some embodiments, the CAC 411 can include a water inlet (not shown) and a water outlet (not shown). The flow of the intake gas between the CAC 411 and the CAC bypass 414 can be controlled via adjustment of the valves 415a, 415b, 415c. The valve 415b can be opened to allow movement of the intake gas through the CAC bypass 414 and the valve 415a can be opened to allow movement of the intake gas through the CAC 411. In some embodiments, both the valve 415a and the valve 415b can be at least partially open to allow movement of the intake gas therethrough.

In some embodiments, 100% of the intake gas can be directed to the CAC 411. In some embodiments, 100% of the intake gas can be directed to the CAC bypass 414. In some embodiments, the partitioning of the intake gas can change during the operation of the engine. In some embodiments, the intake gas can be partitioned between the CAC 411 and the CAC bypass 414 at a ratio of at least about 5:95 (CAC 411 to CAC bypass 414), at least about 10:90, at least about 15:85, at least about 20:80, at least about 25:75, at least about 30:70, at least about 35:65, at least about 40:60, at least about 45:55, at least about 50:50, at least about 55:45, at least about 60:40, at least about 65:35, at least about 70:30, at least about 75:25, at least about 80:20, at least about 85:15, at least about 90:10, or at least about 95:5. In some embodiments, the intake gas can be partitioned between the CAC 411 and the CAC bypass 414 at a ratio of no more than about 95:5, no more than about 90:10, no more than about 85:15, no more than about 80:20, no more than about 75:25, no more than about 70:30, no more than about 65:35, no more than about 60:40, no more than about 55:45, no more than about 50:50, no more than about 45:55, no more than about 40:60, no more than about 35:65, no more than about 30:70, no more than about 25:75, no more than about 20:80, no more than about 15:85, no more than about 10:90, or no more than about 5:95. Combinations of the above-referenced ratios are also possible (e.g., at least about 5:95 and no more than about 95:5 or at least about 30:70 and no more than about 70:30), inclusive of all values and ranges therebetween. In some embodiments, the intake gas can be partitioned between the CAC 411 and the CAC bypass 414 at a ratio of about 5:95, about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, about 95:5.

The EGR cooler bypass 419 receives recirculated exhaust from the combustion chambers. The valve 415d guides the flow of exhaust through the EGR cooler bypass 419. In some embodiments, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95% of the exhaust from the combustion chambers is routed to the EGR cooler bypass 419, inclusive of all values and ranges therebetween.

The intake heaters 420 are shown placed at strategic locations. Any combination of these placements is possible (i.e., a heater can be placed at the location of the intake heater 420a, the location of the intake heater 420b, the location of intake heater 420c, or any combination thereof). The placement of the intake heater 420a on the CAC bypass 414 can allow a selective amount of the intake gas to be heated (i.e., the amount that bypasses the CAC). The placement of the intake heater 420b can allow all of the intake gas to be exposed to heat. The placement of the intake heater 420c can allow the intake gas to be heated after merging with the EGR gas from the EGR cooler bypass 419. The location of the one or more intake heaters 420 can be selected based on how much heat is desired and how quickly the heat is to dissipate. The amount of energy imparted to the intake heaters 420 can be a function of the desired temperature of the intake gas upon entering the combustion chambers.

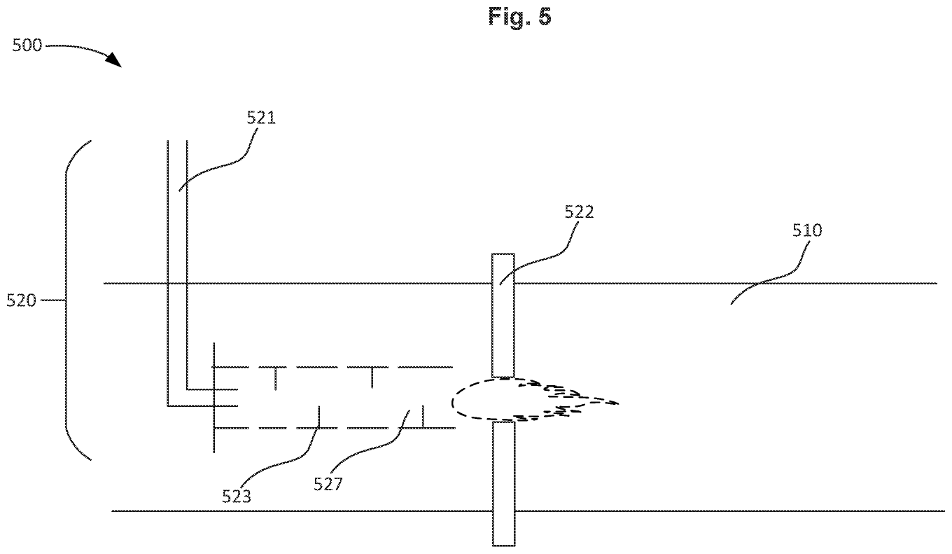

FIG. 5 is an illustration of a system 500 including an intake heater 520 disposed in an intake flow path 510, according to an embodiment. As shown, the intake heater 520 includes a fuel line 521, igniters 522, and perforated baffles 523 enclosing a fuel intake gas mixture flow volume 527. In some embodiments, the intake flow path 510 and the intake heater 520 can be the same or substantially similar to the intake flow path 110 and the intake heater 120, as described above with reference to FIG. 1. Thus, certain aspects of the intake flow path 510 and the intake heater 520 are not described in greater detail herein.

The intake heater 520 acts as an integrated fuel feeding unit, igniter, and burner. Accordingly, the intake heater 520 includes a heating element (i.e., a flame emerging from the terminal end of the fuel line 521) encased in a body (i.e., the perforated baffles 523), and the tip of the flame emerging from the fuel line 521 is exposed to the intake gas moving through the intake flow path 510. Fuel enters the fuel intake gas mixture flow volume 527 and is routed toward the igniters 522. The perforated baffles 523 allow oxygen to mix in with the fuel in the fuel intake gas mixture flow volume 527, such that the fuel is oxygen-rich by the time it reaches the distal end (i.e., the downstream terminal end) of the perforated baffles 523. The fuel then ignites in the oxygen-rich distal end of the perforated baffles 523 near the igniters 522.

The fuel line 521 feeds the fuel from a fuel source (e.g., a fuel tank) to the fuel intake gas mixture flow volume 527. The fuel line 521 is coupled to the perforated baffles 523. In some embodiments, the fuel line 521 can be composed of a metal. In some embodiments, the fuel line 521 can be composed of stainless steel, aluminum, or coated steel. In some embodiments, the fuel line 521 can be composed of a flexible polymer (e.g., plastic tubing). In some embodiments, the fuel line 521 can include Tygon® tubing. In some embodiments, the fuel fed through the fuel line 521 can be the same as the fuel combusted in the combustion chambers. In some embodiments, the fuel fed through the fuel line 521 can be different from the fuel combusted in the combustion chambers.

In some embodiments, the fuel intake gas mixture flow volume 527 can have a circular cross section (i.e., a circular cross section, through which the fuel advances). In some embodiments, the fuel flow volume can have an elliptical cross section. In some embodiments, the fuel flow intake gas mixture volume 527 can have an irregular cross section.

The igniters 522 ignite the fuel exiting the fuel line 521. In some embodiments, the igniters 522 can include one or more spark plugs, glow plugs, hot surface igniters, plasma igniters, or any combination thereof. The igniters 522 are positioned downstream of the fuel flow volume 527. In some embodiments, the igniters 522 can be positioned such that the fuel/intake gas mix is optimal for combustion when the fuel/intake gas reaches the igniters 522. In some embodiments, the igniters 522 can be positioned about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm downstream of a terminal end of the fuel intake gas mixture flow volume 527, inclusive of all values and ranges therebetween.

The perforated baffles 523 create a tortuosity of the flow path of the fuel as it moves through the fuel intake gas mixture flow volume 527. In some embodiments, the tortuosity of the fuel intake gas mixture flow volume 527 can be at least about 1.1, at least about 1.2, at least about 1.3, at least about 1.4, at least about 1.5, at least about 1.6, at least about 1.7, at least about 1.8, at least about 1.9, at least about 2, at least about 3, at least about 4, at least about 5, at least about 6, at least about 7, at least about 8, or at least about 9. In some embodiments, the tortuosity of the fuel intake gas mixture flow volume 527 can be no more than about 10, no more than about 9, no more than about 8, no more than about 7, no more than about 6, no more than about 5, no more than about 4, no more than about 3, no more than about 2, no more than about 1.9, no more than about 1.8, no more than about 1.7, no more than about 1.6, no more than about 1.5, no more than about 1.4, no more than about 1.3, or no more than about 1.2. Combinations of the above-referenced tortuosity values are also possible (e.g., at least about 1.1 and no more than about 10 or at least about 1.5 and no more than about 5), inclusive of all values and ranges therebetween. In some embodiments, the tortuosity of the fuel intake gas mixture flow volume 527 can be about 1.1, about 1.2, about 1.3, about 1.4, about 1.5, about 1.6, about 1.7, about 1.8, about 1.9, about 2, about 3, about 4, about 5, about 6, about 7, about 8, about 9, or about 10.

The fuel intake gas mixture flow volume 527 has a smaller diameter than the intake flow path 510. This allows the intake gas to flow around the intake heater 520 in the annular space between the fuel intake gas mixture flow volume 527 and the walls of the intake flow path 510. In some embodiments, the ratio of the inner diameter of intake flow path 510 to the inner diameter of the fuel flow volume 527 can be about 1.1:1, about 1.2:1, about 1.3:1, about 1.4:1, about 1.5:1, about 1.6:1, about 1.7:1, about 1.8:1, about 1.9:1, about 2:1, about 3:1, about 4:1, about 5:1, about 6:1, about 7:1, about 8:1, about 9:1, or about 10:1, inclusive of all values and ranges therebetween.

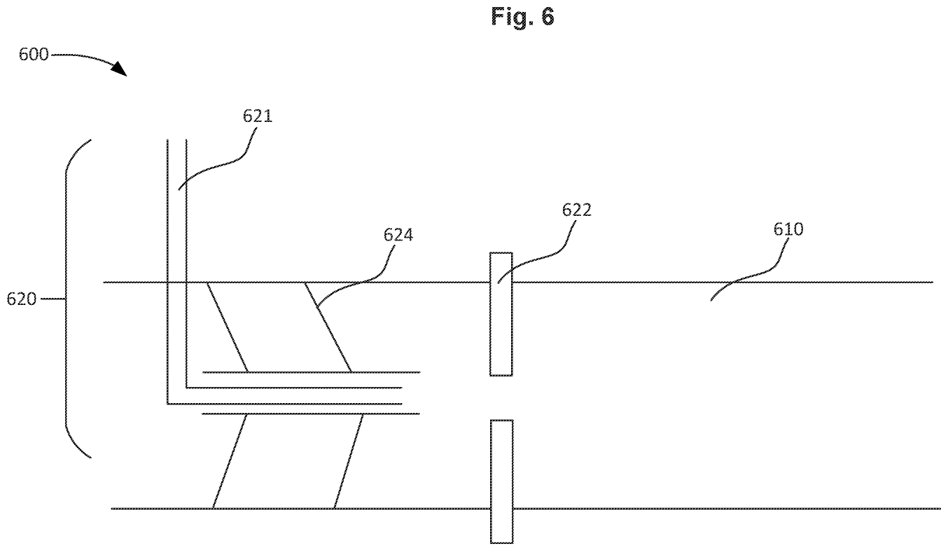

FIG. 6 is an illustration of a system 600 including an intake heater 620 disposed in an intake flow path 610, according to an embodiment. As shown, the intake heater 620 includes a fuel line 621, igniters 622, and swirl blades 624. In some embodiments, the intake flow path 610, the intake heater 620, the fuel line 621, and the igniters 622 can be the same or substantially similar to the intake flow path 510, the intake heater 520, the fuel line 521, and the igniters 522, as described above with reference to FIG. 5. Thus, certain aspects of the intake flow path 610, the intake heater 620, the fuel line 621, and the igniters 622 are not described in greater detail herein.

The swirl blades 624 can enhance combustion and mixing of the fuel and the intake air not used in combustion. The swirl blades 624 can enhance turbulence of intake gas as it flows through the intake flow path 610. In some embodiments, the tortuosity of a flow path through the swirl blades 624 can be at least about 1.1, at least about 1.2, at least about 1.3, at least about 1.4, at least about 1.5, at least about 1.6, at least about 1.7, at least about 1.8, at least about 1.9, at least about 2, at least about 3, at least about 4, at least about 5, at least about 6, at least about 7, at least about 8, or at least about 9. In some embodiments, the tortuosity of the flow path through the swirl blades 624 can be no more than about 10, no more than about 9, no more than about 8, no more than about 7, no more than about 6, no more than about 5, no more than about 4, no more than about 3, no more than about 2, no more than about 1.9, no more than about 1.8, no more than about 1.7, no more than about 1.6, no more than about 1.5, no more than about 1.4, no more than about 1.3, or no more than about 1.2. Combinations of the above-referenced tortuosity values are also possible (e.g., at least about 1.1 and no more than about 10 or at least about 1.5 and no more than about 5), inclusive of all values and ranges therebetween. In some embodiments, the tortuosity of the flow path through the swirl blades 624 can be about 1.1, about 1.2, about 1.3, about 1.4, about 1.5, about 1.6, about 1.7, about 1.8, about 1.9, about 2, about 3, about 4, about 5, about 6, about 7, about 8, about 9, or about 10.

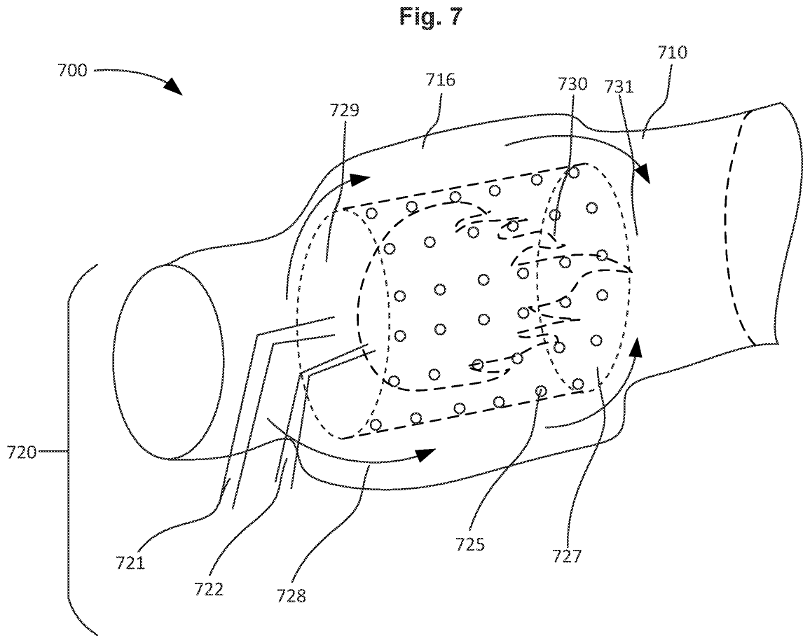

FIG. 7 is an illustration of a system 700 including an intake heater 720 disposed in an intake flow path 710, according to an embodiment. As shown, the intake flow path 710 includes an annular space 716 around the intake heater 720. As shown, the intake heater 720 includes a fuel line 721, an igniter 722, perforations 725, and a fuel flow volume 727. In some embodiments, the intake flow path 710, the intake heater 720, the fuel line 721, the igniter 722, and the fuel flow volume 727 can be the same or substantially similar to the intake flow path 510, the intake heater 520, the fuel line 521, the igniter 522, and the fuel flow volume 527 as described above with reference to FIG. 5. Thus, certain aspects of the intake flow path 710, the intake heater 720, the fuel line 721, the igniter 722, and the fuel flow volume 727 are not described in greater detail herein.

As shown, the fuel flow volume 727 is mounted in the intake flow path 710 with an expanded area of the intake flow path 710 (including the annular space 716) to reduce flow pressure loss of the intake gas on the downstream side of the fuel flow volume 727. The intake heater 720 can include a diffusion region 728 within the fuel flow volume 727 as well as a recirculation region 729 to heat air used for combustion from the heat of the burned gases. The intake heater 720 can include a combustion region 730 and a dilution region 731 to recombine the intake gas not used in combustion with combustion products. As shown, the igniter 722 is located only slightly downstream of the entry of the fuel into the fuel flow volume 727 from the fuel line 721. In some embodiments, the igniter 722 can be located about 1 mm, about 2 mm, about 3 mm, about 4 mm, about 5 mm, about 6 mm, about 7 mm, about 8 mm, about 9 mm, about 1 cm, about 1.5 cm, about 2 cm, about 2.5 cm, about 3 cm, about 3.5 cm, about 4 cm, about 4.5 cm, or about 5 cm downstream of the entry of the fuel into the fuel flow volume 727 from the fuel line 721, inclusive of all values and ranges therebetween.

As shown, the intake flow path 710 includes an expansion or bulge around the fuel flow volume 727 to accommodate the movement of the intake gas around the outside of the fuel flow volume 727. In some embodiments, the expansion of the intake flow path 710 can have a larger diameter than the rest of the intake flow path 710 by a factor of about 1.1:1, about 1.2:1, about 1.3:1, about 1.4:1, about 1.5:1, about 1.6:1, about 1.7:1, about 1.8:1, about 1.9:1, about 2:1, about 3:1, about 4:1, about 5:1, about 6:1, about 7:1, about 8:1, about 9:1, or about 10:1, inclusive of all values and ranges therebetween.

The perforations 725 around the outside of the fuel flow volume 727 allow for the mixing of the fuel with the intake gas as the fuel moves through the fuel flow volume 727. As shown, the perforations 725 are oriented in parallel rows. In some embodiments, the perforations 725 can be oriented in offset or scattered rows. The perforations 725 can have a perforation density on the surface area of the outside of the fuel flow volume 727. In some embodiments, the perforations 725 can have a perforation density on the surface area of the outside of the fuel flow volume of about 1 perforation/cm², about 2 perforations/cm², about 3 perforations/cm², about 4 perforations/cm², about 5 perforations/cm², about 6 perforations/cm², about 7 perforations/cm², about 8 perforations/cm², about 9 perforations/cm², or about 10 perforations/cm², inclusive of all values and ranges therebetween.

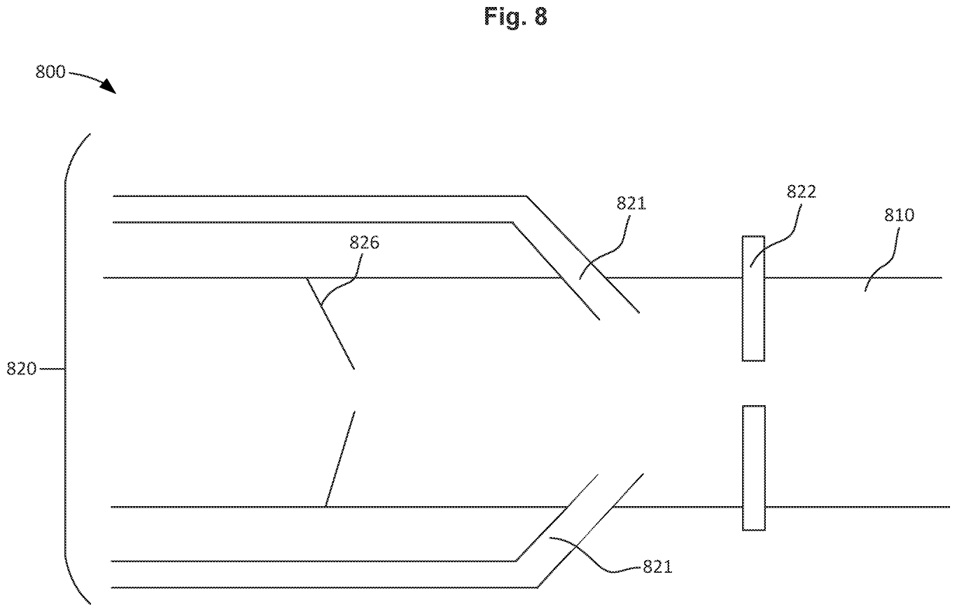

FIG. 8 is an illustration of a system 800 including an intake heater 820 disposed in an intake flow path 810, according to an embodiment. As shown, the intake heater 820 includes fuel lines 821, igniters 822, and flame protectors 826. In some embodiments, the intake flow path 810, the intake heater 820, the fuel lines 821, and the igniters 822 can be the same or substantially similar to the intake flow path 510, the intake heater 520, the fuel line 521, and the igniters 522, as described above with reference to FIG. 5. Thus, certain aspects of the intake flow path 810, the intake heater 820, the fuel lines 821, and the igniters 822 are not described in greater detail herein.

In some embodiments, the intake heater 820 can include one or more flame detectors (not shown). The flame detectors can detect whether a flame is active in the intake flow path 810. In some embodiments, the flame detectors can include temperature sensors, thermocouples, and/or flame ionization detectors. As shown, the igniters 822 are located downstream of the entry of the fuel into the intake flow path 810 from the fuel lines 821. In some embodiments, the igniters 822 can be integrated into the same component as the fuel lines 821.

In some cases, the temperature in the intake flow path 810 can reach 200° C. or more, which can be well above the boiling point of some small-molecule liquid fuels. The liquid portion of the fuel can be housed within the fuel lines 821 and substantially open to the ambient environment (i.e., the space adjacent to the engine but still under the hood or inside the engine compartment). As shown, the fuel enters the intake flow path via two fuel lines 821. In some embodiments, the fuel can enter the intake flow path via 1, 2, 3, 4, 5, 6, 7, 8, 9, 10, or at least about 10 fuel lines, inclusive of all values and ranges therebetween. The flame protectors 826 prevent the intake gas from blowing out the fire formed by the ignition of the fuel from the fuel inlets 821. In some embodiments, the flame protectors 826 can be disposed around an outside edge and along an inside surface of the intake flow path 810.

In some embodiments, the intake gas and the fuel can be premixed (e.g., in a gaseous phase and mixed with intake gases or supplemental air supply) before encountering any igniters. The intake gas-fuel mixture then burns downstream of a flame anchor where flame speed and incoming velocity match. The fuel can burn in regions that are stoichiometric or substantially stoichiometric.

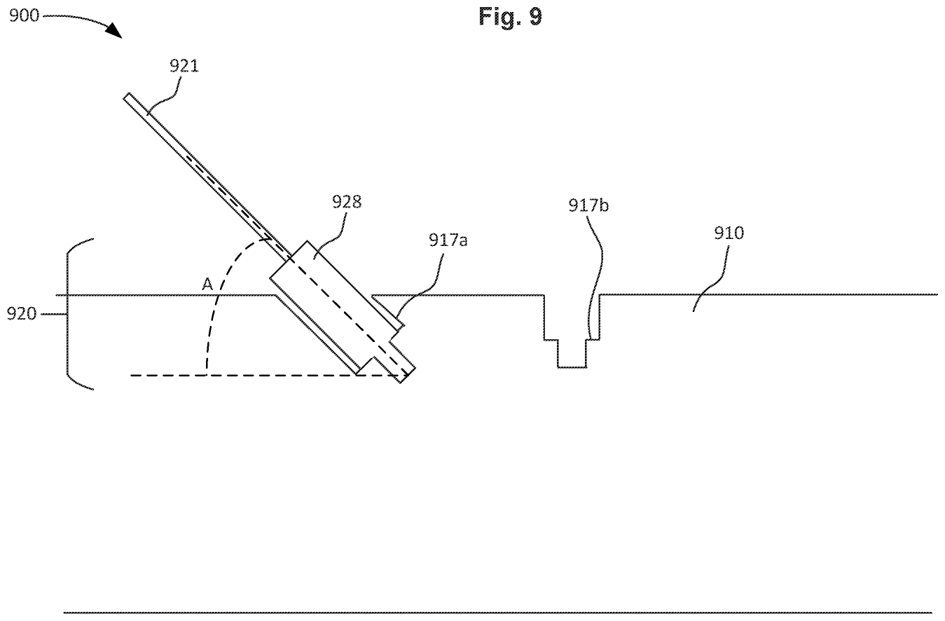

FIG. 9 is an illustration of a system 900 including an intake heater 920 disposed in an intake flow path 910, according to an embodiment. As shown, the intake heater 920 includes a fuel line 921 feeding to a fuel injector 928. As shown, the intake flow path includes slots 917a, 917b (collectively referred to as slots 917) for placement of one or more fuel injectors 928. In some embodiments, the flow path 910, the intake heater 920, and the fuel line 921 can be the same or substantially similar to the flow path 510, the intake heater 520, and the fuel line 521, as described above with reference to FIG. 5. Thus, certain aspects of the flow path 910, the intake heater 920, and the fuel line 921 are not described in greater detail herein.

One or more fuel injectors 928 can secure into the fuel line slots 917. As shown, the intake flow path 910 includes 2 slots 917 for placement of the fuel injector 928. In some embodiments, the intake flow path 910 can include 1, 2, 3, 4, 5, 6, 7, 8, 9, 10, or at least about 10 slots 917, inclusive of all values and ranges therebetween. As shown, the fuel line 921 is coupled to the fuel injector 928 and delivers fuel to the fuel injector 928.

As shown, the slots 917 are formed, such that the fuel injector 928 fits into the slots 917 and forms a characteristic incidence angle A, or an angle formed with the flow direction of intake gas as the intake gas moves through the intake flow path 910. The incidence angle A can be formed to inject the fuel into the intake flow path at an advantageous angle (e.g., to limit uncombusted fuel and/or to prevent blowout). In some embodiments, the incidence angle A can be at least about 5 degrees, at least about 10 degrees, at least about 15 degrees, at least about 20 degrees, at least about 25 degrees, at least about 30 degrees, at least about 35 degrees, at least about 40 degrees, at least about 45 degrees, at least about 50 degrees, at least about 55 degrees, at least about 60 degrees, at least about 65 degrees, at least about 70 degrees, at least about 75 degrees, at least about 80 degrees, or at least about 85 degrees. In some embodiments, the incidence angle A can be no more than about 90 degrees, no more than about 85 degrees, no more than about 80 degrees, no more than about 75 degrees, no more than about 70 degrees, no more than about 65 degrees, no more than about 60 degrees, no more than about 55 degrees, no more than about 50 degrees, no more than about 45 degrees, no more than about 40 degrees, no more than about 35 degrees, no more than about 30 degrees, no more than about 25 degrees, no more than about 20 degrees, no more than about 15 degrees, or no more than about 10 degrees. Combinations of the above-referenced incidence angles A are also possible (e.g., at least about 5 degrees and no more than about 90 degrees or at least about 30 degrees and no more than about 60 degrees, inclusive of all values and ranges therebetween. In some embodiments, the incidence angle A can be about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, or about 90 degrees.

The fuel injectors 928 can be protected by blowing compressed air through the intake flow path 810 after operation of the engine in order to purge any liquid fuel from the fuel injectors 928. Alternatively, the fuel injectors 928 can be protected from high temperatures via the installation of a pressurizing valve (not shown) in the fuel injectors 928. This can allow the fuel pressure to be kept high enough to prevent boiling at temperatures up to 200° C. The pressurizing valve can open passively or electrically when fuel injection is needed. A passively operated valve can open above a specified pressure, which would be above the fuel boiling point.

In some embodiments, air assisted nozzles (not shown) can be installed in or near the fuel injectors 928 to drive fuel atomization for liquid fuels. In some cases, the fuel and/or the air used for the air assist can be heated to compensate for cooling from the heat of vaporization of the liquid fuel.

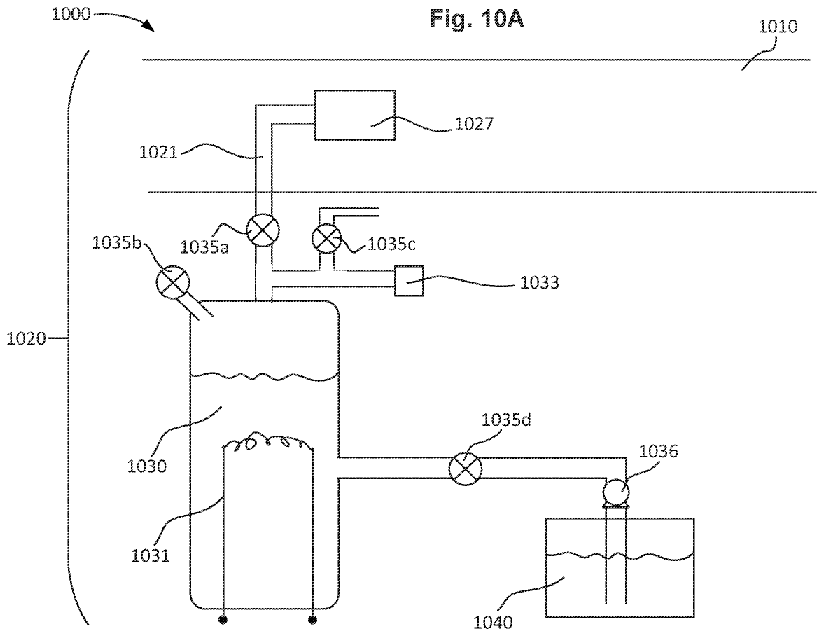

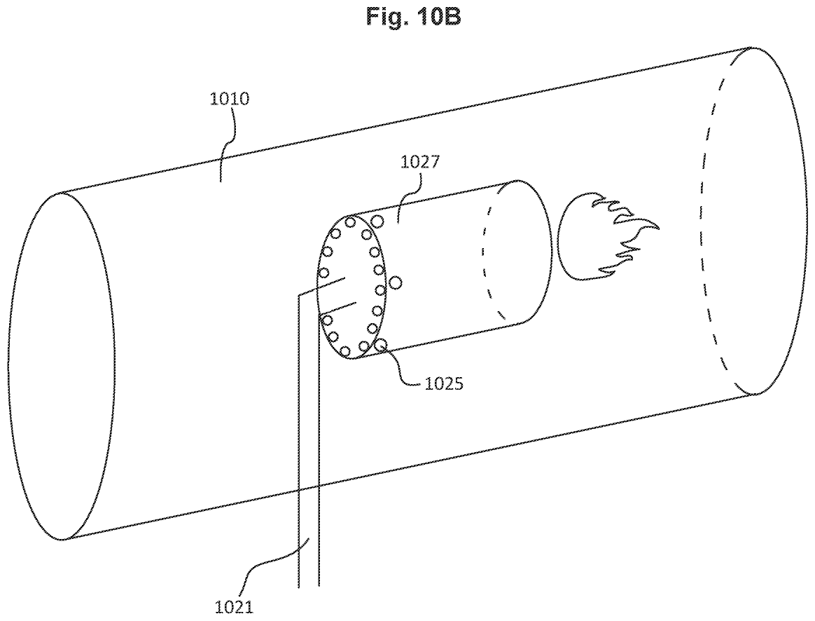

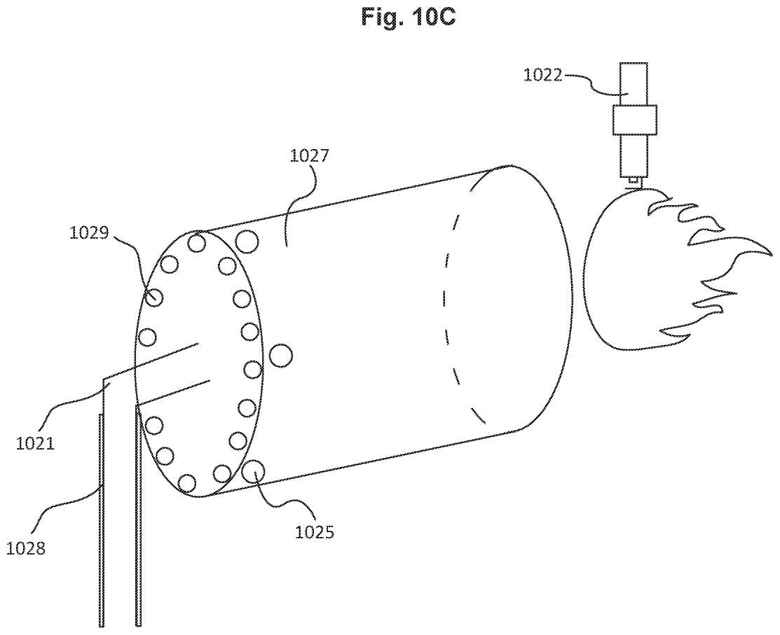

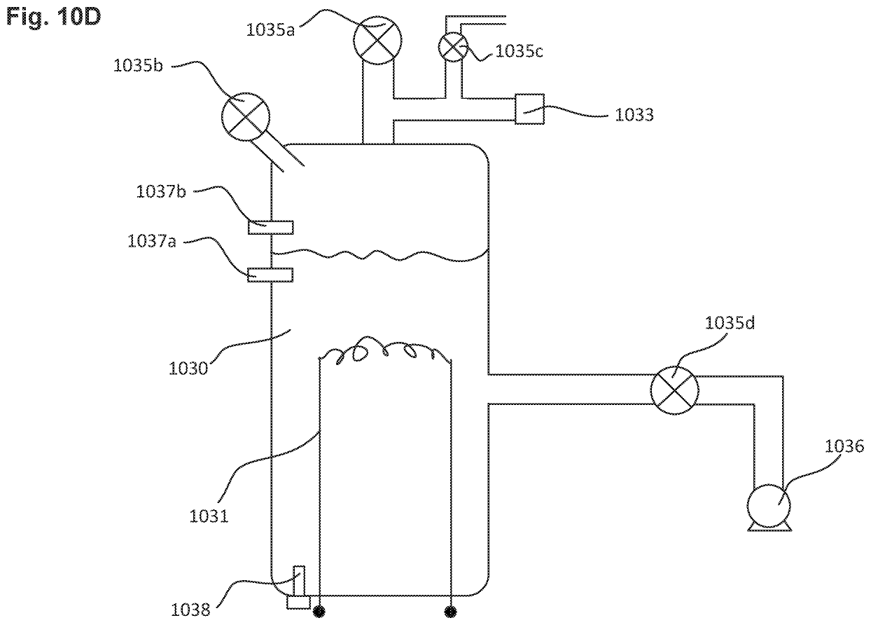

FIGS. 10A-10D are illustrations of a small-molecule premixed fuel burner system 1000, according to an embodiment. An intake flow path 1010 and an intake heater 1020 are shown. The intake heater 1020 includes a fuel line 1021 and a fuel flow volume 1027. In some embodiments, the intake flow path 1010, the intake heater 1020, the fuel line 1021, and the fuel flow volume 1027 can be the same or substantially similar to the intake flow path 510, the intake heater 520, the fuel line 521, and the fuel flow volume 527, as described above with reference to FIG. 5. Thus, certain aspects of the intake flow path 1010, the intake heater 1020, the fuel line 1021, and the fuel flow volume 1027 are not described in greater detail herein.

As shown in FIG. 10A, the intake heater 1020 includes a fuel heating tank 1030 with a heating element 1031 disposed therein, as well as a fuel supply tank 1040. A pressure sensor 1033 monitors pressure in the intake heater 1020. Valves 1035a, 1035b, 1035c, 1035d (collectively referred to as valves 1035) control movement of fuel throughout the intake heater 1020 and into the intake flow path 1010. A pump 1036 pumps liquid fuel from the fuel supply tank 1040 to the fuel heating tank 1030. The fuel line 1021 delivers fuel in vapor phase from the fuel heating tank 1030 to the intake flow path 1010.

To aid in combustion of small-molecule low cetane fuels, preheating the fuel in the intake heater 1020 can improve the ignitability of the fuels. Fuel preheating can compensate for the high heat of vaporization of many small-molecule liquid fuels and help reach a self-ignition temperature after the ignition source (e.g., an igniter) is turned on. Additionally, a hot surface (e.g., tungsten, Inconnel, or a stainless steel probe) can be placed in the path of the fuel to help sustain combustion. As shown, the fuel is heated electrically via the heating element 1031 disposed in the fuel heating tank 1030. In some embodiments, the fuel line 1021 can run counter-current to the flow of combustion products within the intake flow path 1010 in order to improve heat transfer to the fuel. In some embodiments, the fuel line 1021 can be wrapped around the outer diameter of the fuel line to transfer heat to the fuel before dispensing the fuel into the intake flow path 1010.

The pressure sensor 1033 measures the pressure of the fuel in the intake heater 1020, particularly in the fuel heating tank 1030 and the associated plumbing. In some embodiments, the pressure sensor 1033 can be in communication with either of the valves 1035. The valve 1035a controls movement of fuel from the fuel heating tank 1030 into the intake flow path 1010 via the fuel line 1021. The valve 1035b acts as a release valve from the fuel heating tank 1030. For example, if the pressure sensor 1033 detects a pressure higher than a desired pressure or a setpoint, the valve 1035b can open to release an amount of fuel vapor from the fuel heating tank 1030. The valve 1035c acts as a relief valve for movement of fuel into a purge canister (not shown). The fuel can be saved and/or condensed in the purge canister and fed back to the fuel supply tank 1040. The valve 1035d regulates the flow of fuel between the fuel supply tank 1040 and the fuel heating tank 1030. The pump 1036 facilitates movement of fuel from the fuel supply tank 1040 to the fuel heating tank 1030.

FIG. 10B shows greater detail of the fuel flow volume 1027 disposed in the intake flow path 1010. As shown, the fuel flow volume 1027 includes perforations 1025. The perforations 1025 allow the inflow of intake gas to mix with the fuel and improve combustibility of the fuel. As shown, the fuel flow volume 1027 includes perforations 1025 around the radial edge of the fuel flow volume 1027 as well as on the upstream end of the fuel flow volume 1027. FIG. 10C shows an igniter 1022 disposed downstream of the fuel flow volume 1027. As shown, the igniter 1022 is in the form of a spark plug. In some embodiments, the igniter 1022 can have any of the properties of the igniters 522 described above with reference to FIG. 5. As shown, an insulation layer 1028 is disposed around the outside of the fuel line 1021 to prevent liquid condensation. The insulation layer 1028 prevents loss of heat from the fuel in the fuel line 1021 after the fuel has been heated in the fuel heating tank 1030. In some embodiments, the insulation layer 1028 can be composed of an insulative material, such as a thermal barrier coating.

FIG. 10D shows greater detail of the fuel heating tank 1030. As shown, the fuel heating tank 1030 includes a low level sensor 1037a, a high level sensor 1037b, (collectively referred to as level sensors 1037) and a temperature sensor 1038. Many small molecule fuels (e.g., ethanol) are conductive. Based on this conductivity, contact probes can be used for level sensing. In some embodiments, the level sensors 1037 can include float sensors, capacitive sensors, or other level switch technologies. In some embodiments, the level sensors 1037 can be in communication with the pump 1036, such that the pump 1036 draws fuel into the fuel heating tank 1030 from the fuel supply tank 1040. The temperature sensor 1038 monitors the temperature of the liquid in the fuel heating tank 1030. In some embodiments, the temperature sensor 1038 can be in communication with the heating element 1031. For example, the heating element 1031 can switch off if the temperature sensor 1038 detects the fuel has a temperature higher than a setpoint or a desired value.

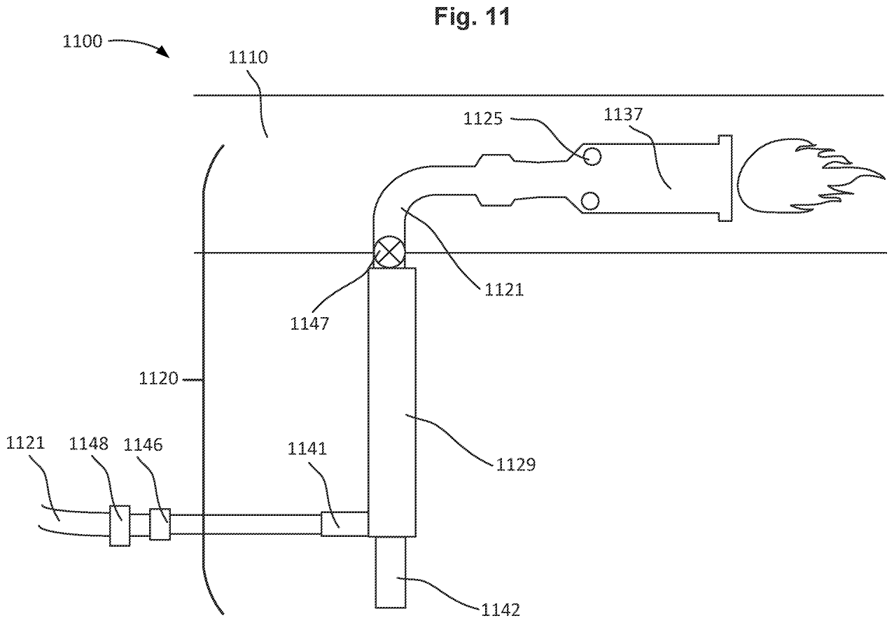

FIG. 11 is an illustration of a small-molecule premixed fuel burner system 1100 with an integrated boiler, according to an embodiment. As shown, the premixed fuel burner system 1100 includes an intake flow path 1110 with an intake heater 1120. The intake heater 1120 includes a fuel line 1121, perforations 1125, a boiling chamber 1129, a premixed chamber 1137, an electrical connection 1142, a valve 1147 regulating movement of fluid into the premixed chamber 1137, a fitting 1146 coupling portions of the fuel line 1121 together, and a filter 1148 for removal of impurities. In some embodiments, the intake flow path 1110, the intake heater 1120, and the fuel line 1121 can be the same or substantially similar to the intake flow path 510, the intake heater 520, and the fuel line 521, as described above with reference to FIG. 5. Thus, certain aspects of the intake flow path 1110, the intake heater 1120, and the fuel line 1121 are not described in greater detail herein.

In use, the fuel is boiled via a glow plug in the boiling chamber 1129. Rather than installing a level, temperature, and pressure sensor, fuel is metered into the boiling chamber 1129 and prepared for combustion. A variable pressure pump with an orifice, a metering pump, or solenoid system can perform the metering function. The filter 1148 removes particulates and impurities from the fuel before the fuel enters the boiling chamber 1129. The fuel inlet 1141 includes an orifice for entry into the boiling chamber 1129. The electrical connection 1142 powers the glow plug in the boiling chamber 1129. The valve 1147 regulates the movement of boiled fluid into the premixed chamber 1137. The valve 1147 can act as a shutoff valve once the engine reaches a steady state operation. In other words, the fuel supply to the intake flow path 1110 can be shut off via the valve 1147. The fuel mixes with the intake gas in the premixed chamber 1137.

In some embodiments, upstream of the boiling chamber 1129, the pressure in the fuel line 1121 can be at least about 0 psi (gauge), at least about 5 psi, at least about 10 psi, at least about 15 psi, at least about 10 psi, at least about 15 psi, at least about 20 psi, at least about 25 psi, at least about 30 psi, at least about 35 psi, at least about 40 psi, at least about 45 psi, at least about 50 psi, at least about 55 psi, at least about 60 psi, at least about 75 psi, at least about 70 psi, at least about 85 psi, at least about 90 psi, at least about 95 psi, at least about 100 psi, at least about 200 psi, at least about 300 psi, at least about 400 psi, at least about 500 psi, at least about 600 psi, at least about 700 psi, at least about 800 psi, or at least about 900 psi. In some embodiments, upstream of the boiling chamber 1129, the pressure in the fuel line 1121 can be no more than about 1,000 psi, no more than about 900 psi, no more than about 800 psi, no more than about 700 psi, no more than about 600 psi, no more than about 500 psi, no more than about 400 psi, no more than about 300 psi, no more than about 200 psi, no more than about 100 psi, no more than about 95 psi, no more than about 90 psi, no more than about 85 psi, no more than about 80 psi, no more than about 75 psi, no more than about 70 psi, no more than about 65 psi, no more than about 60 psi, no more than about 55 psi, no more than about 50 psi, no more than about 45 psi, no more than about 40 psi, no more than about 35 psi, no more than about 30 psi, no more than about 25 psi, no more than about 20 psi, no more than about 15 psi, no more than about 10 psi, or no more than about 5 psi. Combinations of the above-referenced pressures are also possible (e.g., at least about 0 psi and no more than about 1,000 psi or at least about 20 psi and no more than about 200 psi), inclusive of all values and ranges therebetween. In some embodiments, upstream of the boiling chamber 1129, the pressure in the fuel line 1121 can be about 0 psi, about 5 psi, about 10 psi, about 15 psi, about 10 psi, about 15 psi, about 20 psi, about 25 psi, about 30 psi, about 35 psi, about 40 psi, about 45 psi, about 50 psi, about 55 psi, about 60 psi, about 75 psi, about 70 psi, about 85 psi, about 90 psi, at least about 95 psi, at least about 100 psi, at least about 200 psi, at least about 300 psi, at least about 400 psi, at least about 500 psi, at least about 600 psi, at least about 700 psi, at least about 800 psi, about 900 psi, or about 1,000 psi.

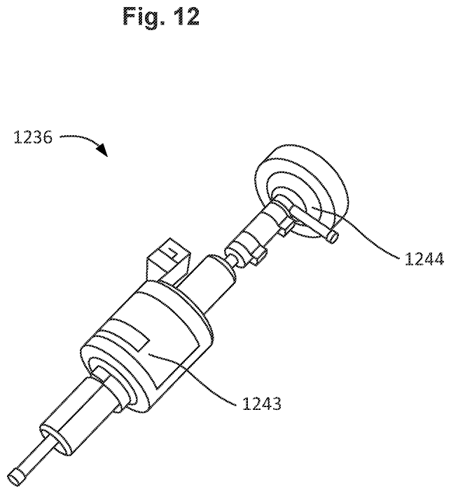

FIG. 12 is a photograph of a metering pump 1236, according to an embodiment. The metering pump 1236 can regulate the flow of fuel into the boiling chamber (e.g., the boiling chamber 1129, as described above with reference to FIG. 11). As shown, the metering pump 1236 includes a pump portion 1243 and a fuel filter 1244. The metering pump 1236 can allow for multiple pulses to each pump a specific quantity of fuel into the boiling chamber or directly to the intake flow path. The frequency of pulsing can accurately control the fuel going to the boiling chamber or to the intake flow path. The fuel can then boil and burn very quickly. The relatively small premixed burner can be placed strategically close to intake ports of the engine for quick heating. In a compact system several metering pumps 1236 can be used to achieve a high combined heat output while giving a fine resolution in low heat output when a high output is not needed. Temperature sensing and/or flame ionization downstream of the combustion of the fuel can be used to detect a flame presence. If a flame presence is not found, the fuel can be turned off and/or a reignition can be attempted. The metering pump 1236 can also be used as an individual flame plug fuel supply.

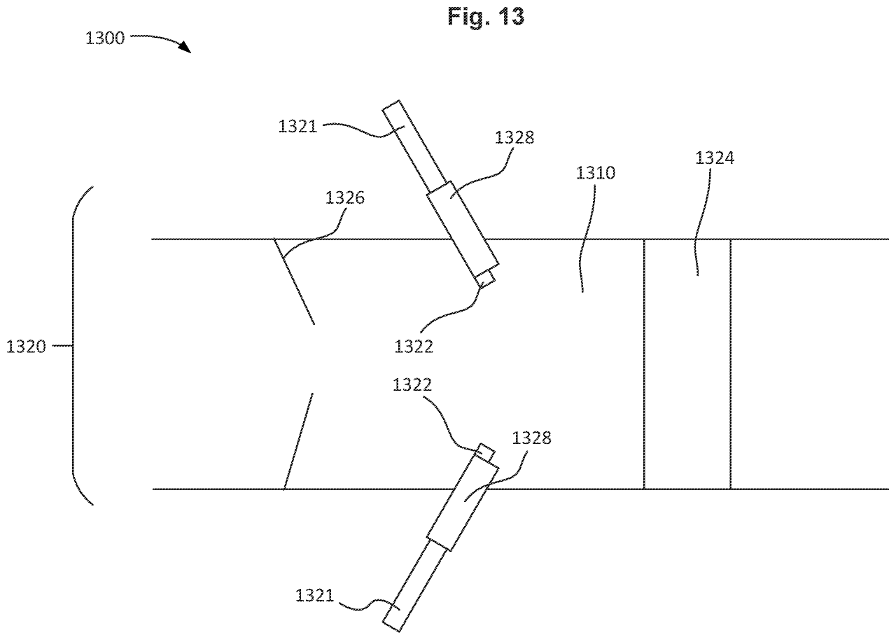

FIG. 13 is an illustration of a small-molecule liquid fuel burner system 1300, according to an embodiment. As shown, the liquid fuel burner system 1300 includes an intake flow path 1310 and an intake heater 1320. As shown, the intake heater 1320 includes fuel lines 1321, igniters 1322, a mixer 1324, flame protectors 1326, and fuel injectors 1328. In some embodiments, the intake flow path 1310, the intake heater 1320, the fuel line 1321, and the igniters 1322 can be the same or substantially similar to the intake flow path 510, the intake heater 510, the fuel line 521, and the igniters 522, as described above with reference to FIG. 5. In some embodiments, the flame protectors 1326 can be the same or substantially similar to the flame protectors 826, as described above with reference to FIG. 8. In some embodiments, the fuel injectors 1328 can be the same or substantially similar to the fuel injector 928, as described above with reference to FIG. 9. Thus, certain aspects of the intake heater 1320, the fuel line 1321, the igniters 1322, the flame protectors 1326, and the fuel injectors 1328 are not described in greater detail herein.

As shown, the fuel injectors 1328 and the igniters 1322 are integrated into the same piece of material. This can improve the compactness of the system 1300 and the ease of installation of the components. The mixer 1324 is integrated into the intake flow path 1310. The mixer 1324 creates turbulence in the heated intake gas, such that it mixes better with the combusted fuel. In some embodiments, the mixer 1324 can include ridges to increase turbulence and tortuosity. In some embodiments, the mixer 1324. In some embodiments, the tortuosity of the flow path through the fuel injectors 1328 can be about 1.1, about 1.2, about 1.3, about 1.4, about 1.5, about 1.6, about 1.7, about 1.8, about 1.9, about 2, about 3, about 4, about 5, about 6, about 7, about 8, about 9, or about 10.

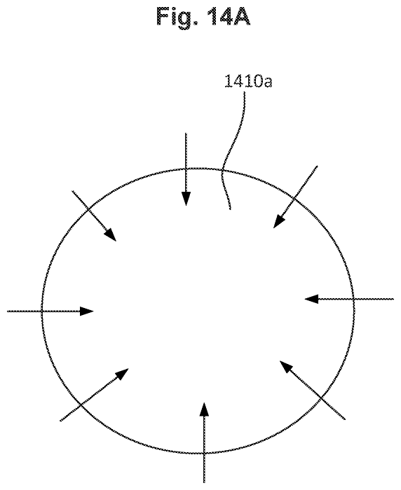

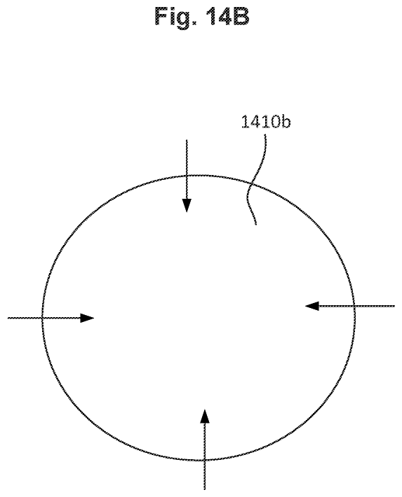

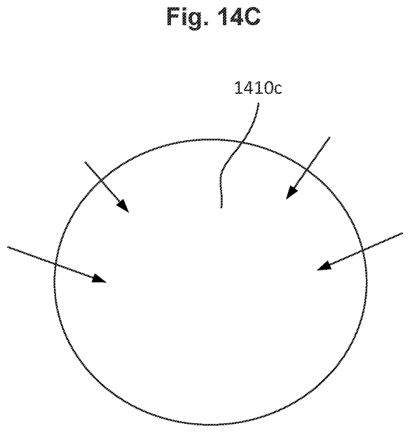

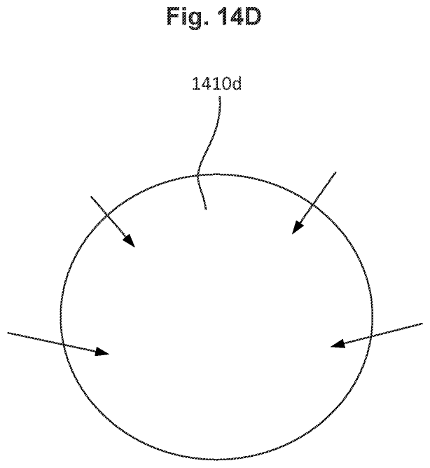

FIGS. 14A-14D show cross sections of flow paths 1410a, 1410b, 1410c, 1410d (collectively referred to as flow paths 1410) with various locations and incidence angles of fuel injectors or flame plugs depicted, according to various embodiments. FIG. 14A shows a cross section of the intake flow path 1410a with 8 fuel injectors or flame plugs disposed around the outside of the flow path intake 1410a and evenly spaced. FIG. 14B shows a cross section of the intake flow path 1410b with 4 fuel injectors or flame plugs disposed around the outside of the intake flow path 1410b and evenly spaced. FIG. 14C shows four fuel injectors or flame plugs located above a vertical midpoint of the intake flow path 1410c and oriented such that they do not all point at the center of the cross section of the intake flow path 1410c. FIG. 14D shows four fuel injectors or flame plugs unevenly spaced around the outside of the intake flow path 1410d with two fuel injectors or flame plugs located above the vertical midpoint of the intake flow path 1410d and two fuel injectors or flame plugs located below the vertical midpoint of the intake flow path.

In some embodiments, at least about 1, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, or at least about 90 fuel injectors can be disposed in the intake flow paths 1410. In some embodiments, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, no more than about 3, or no more than about 2 fuel injectors can be disposed in the intake flow paths 1410. Combinations of the above-referenced numbers of fuel injectors are also possible (e.g., at least about 1 and no more than about 100 or at least about 4 and no more than about 40), inclusive of all values and ranges therebetween. In some embodiments, about 1, about 2, about 3, about 4, about 5, about 6, about 7, about 8, about 9, about 10, about 20, about 30, about 40, about 50, about 60, about 70, about 80, about 90, or about 100 fuel injectors can be disposed in the intake flow paths 1410.

In some embodiments, the spacing between the fuel injectors or flame plugs around the outside of the intake flow paths 1410 can be even. In some embodiments, the spacing between the fuel injectors or flame plugs around the outside of the intake flow paths 1410 can be even. In some embodiments, the fuel injectors or flame plugs can be spaced apart by about 1 degree, about 5 degrees, about 10 degrees, about 20 degrees, about 30 degrees, about 40 degrees, about 50 degrees, about 60 degrees, about 70 degrees, about 80 degrees, about 90 degrees, about 100 degrees, about 110 degrees, about 120 degrees, about 130 degrees, about 140 degrees, about 150 degrees, about 160 degrees, about 170 degrees, or about 180 degrees, inclusive of all values and ranges therebetween. In some embodiments, the fuel injectors or flame plugs can point toward the center of the cross section of the intake flow paths 1410. In some embodiments, the fuel injectors or flame plugs can point away from the center of the intake flow paths 1410. In some embodiments, one or more of the fuel injectors or flame plugs can form an angle with a hypothetical fuel injector or flame plug that points toward the center of the cross section of the intake flow paths 1410. In some embodiments, this angle can be about 1 degree, about 2 degrees, about 3 degrees, about 4 degrees, about 5 degrees, about 6 degrees, about 7 degrees, about 8 degrees, about 9 degrees, about 10 degrees, about 15 degrees, about 20 degrees, about 25 degrees, about 30 degrees, about 35 degrees, about 40 degrees, about 45 degrees, about 50 degrees, about 55 degrees, or about 60 degrees, inclusive of all values and ranges therebetween.

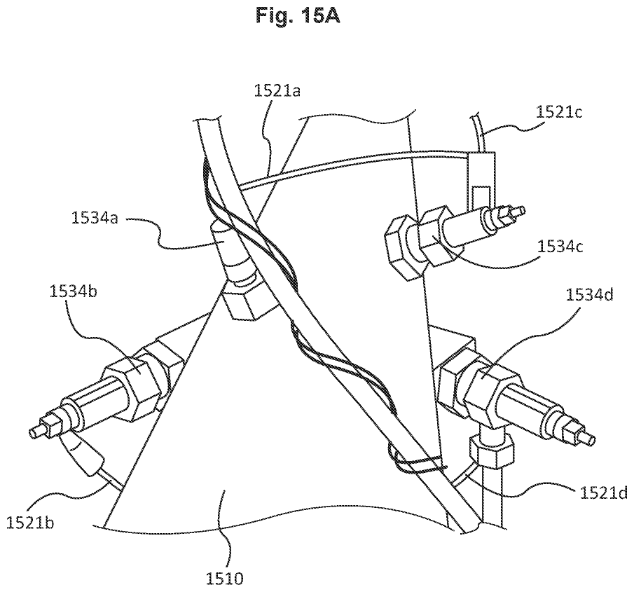

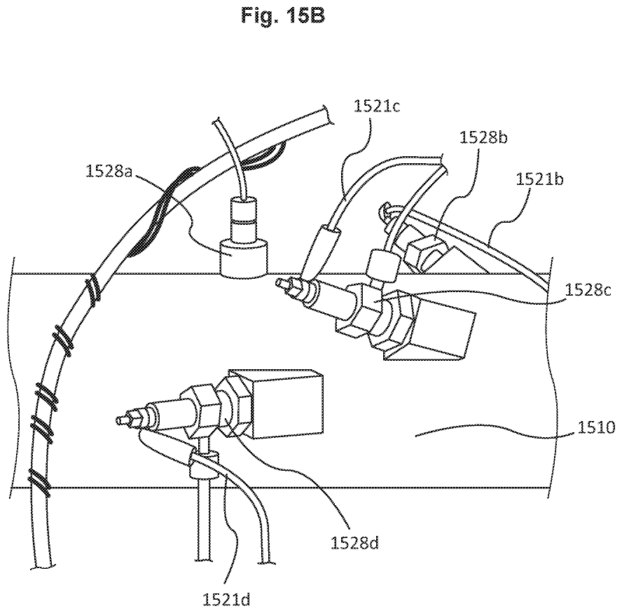

FIGS. 15A-15B show photographs of an intake flow path 1510 with flame plugs 1534a, 1534b, 1534c, 1534d (collectively referred to as flame plugs 1534) disposed therein, according to an embodiment. As shown, the flame plugs 1534 are coupled to fuel lines 1521a, 1521b, 1521c, 1521c (collectively referred to as fuel lines 1521). In some embodiments, the intake flow path 1510 and the fuel lines 1521 can be the same or substantially similar to the intake flow path 910 and the fuel lines 921, as described above with reference to FIG. 9. Thus, certain aspects of the intake flow path 1510 and the fuel lines 1521 are not described in greater detail herein. FIG. 15A shows an overhead auxiliary view of the intake flow path 1510, while FIG. 15B shows a side view of the intake flow path 1510.

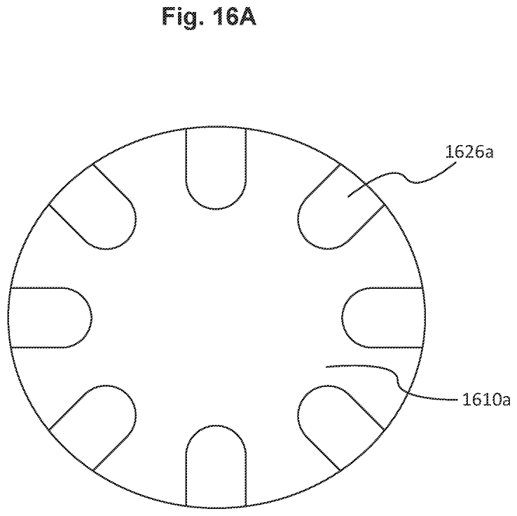

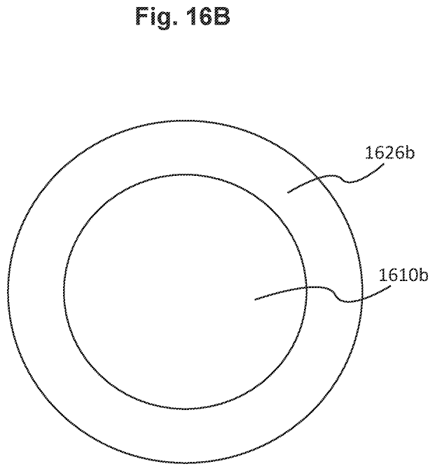

FIGS. 16A-16B show cross sections of flame protectors 1626a, 1626b (collectively referred to as flame protectors 1626) disposed in intake flow paths 1610a, 1610b (collectively referred to as intake flow paths 1610), according to various embodiments. In some embodiments, the intake flow paths 1610 and the flame protectors 1626 can be the same or substantially similar to the intake flow path 1310 and the flame protectors 1326, as described above with reference to FIG. 13. Thus, certain aspects of the intake flow paths 1610 and the flame protectors 1626 are not described in greater detail herein.

FIG. 16A shows multiple flame protectors 1626a disposed around the outside of the intake flow path 1610a. As shown, the flame protectors 1626a are evenly spaced around the outside of the intake flow path 1610a. As shown, 8 flame protectors 1626a are spaced around the outside of the intake flow path 1610a. In some embodiments, about 1, about 2, about 3, about 4, about 5, about 6, about 7, about 8, about 9, about 10, about 20, about 30, about 40, about 50, about 60, about 70, about 80, about 90, or about 100 flame protectors 1626a can be spaced around the outside of the intake flow path 1610a, inclusive of all values and ranges therebetween. As shown, the flame protectors 1626a are evenly spaced around the outside of the intake flow path 1610a. In some embodiments, the flame protectors 1626a can be unevenly spaced around the outside of the intake flow path 1610a. In some embodiments, the flame protectors 1626a can be spaced apart by about 1 degree, about 5 degrees, about 10 degrees, about 20 degrees, about 30 degrees, about 40 degrees, about 50 degrees, about 60 degrees, about 70 degrees, about 80 degrees, about 90 degrees, about 100 degrees, about 110 degrees, about 120 degrees, about 130 degrees, about 140 degrees, about 150 degrees, about 160 degrees, about 170 degrees, or about 180 degrees, inclusive of all values and ranges therebetween. In some embodiments, the flame protectors 1626a can be aligned with fuel injectors (not shown) and/or igniters (not shown). In other words, the flame protectors 1626a can be placed at the same circumferential position as the fuel injectors and/or the igniters, such that the flame protectors 1626a effectively block intake gas from blowing out the flames produced by the fuel injectors and the igniters.

In FIG. 16B the single flame protector 1626b is disposed around the entire perimeter of the edge of the intake flow path 1610b. As shown, the flame protector 1626b extends inward from the edge of the intake flow path 1610b. In some embodiments, the flame protector 1626b can reduce the effective diameter of the intake flow path 1610b by a factor of about 1.1, about 1.2, about 1.3, about 1.4, about 1.5, about 1.6, about 1.7, about 1.8, about 1.9, about 2, about 3, about 4, about 5, about 6, about 7, about 8, about 9, or about 10, inclusive of all values and ranges therebetween.

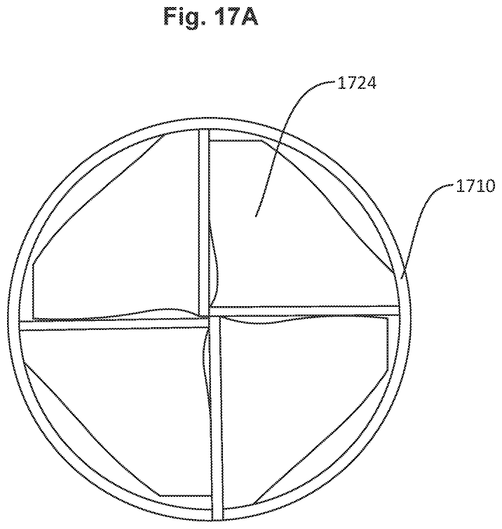

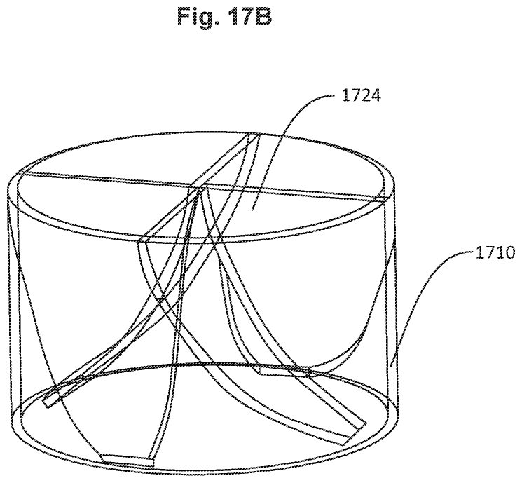

FIGS. 17A-17B show views of a mixer 1724 disposed in an intake flow path 1710, according to an embodiment. In some embodiments, the intake flow path 1710 and the mixer 1724 can be the same or substantially similar to the intake flow path 1310 and the mixer 1324, as described above with reference to FIG. 13. Thus, certain aspects of the intake flow path 1710 and the mixer 1724 are not described in greater detail herein. FIG. 17A shows a cross-sectional view of the mixer 1724 disposed in the intake flow path 1710, while FIG. 17B shows a transparent auxiliary view of the mixer 1724 disposed in the intake flow path 1710.

The mixer 1724 can be disposed downstream of fuel injectors and/or igniters. As shown, the inlet portion of the mixer 1724 is perpendicular to the flow direction of the gases moving through the intake flow path 1710. As shown in FIG. 17A, the mixer 1724 is divided into 4 sections for flow to divert from a first section to an adjacent second section. In some embodiments, the mixer 1724 can have 2, 3, 4, 5, 6, 7, 8, 9, 10, or at least about 10 sections, inclusive of all values and ranges therebetween. Strong swirl is generated via the mixer 1724 and facilitates temperature mixing and homogenization.

Tests in a flow rig have shown that mixer designs such as the mixer 1724 can deliver significantly higher temperature uniformity, as compared to engines without a mixer. The temperature variability downstream of the mixer 1724 can be reduced to a desired level. Additionally, the mixer 1724 offers design flexibility in balancing between pressure loss and a mixing effect. If the pressure drop of the mixer is a design target, each blade in the mixer 1724 can be bent to allow flow resistance to vary for specific target applications. Design features of the mixer 1724 can include variable flow resistance or blockage area by bending the blade angles at a location downstream of the blades of the mixer 1724. The mixer 1724 can also include upstream sections of the blades that are parallel to the flow direction of the gases at the inlet of the mixer 1724 to minimize flow resistance. The welding area of the blades can act as an overlap area between the intake flow path 1710 and the mixer 1724.

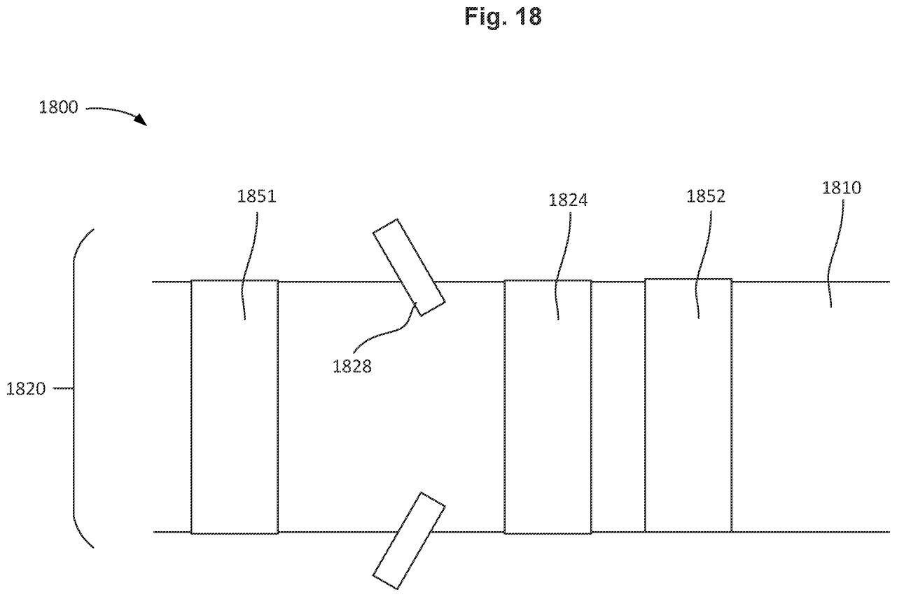

FIG. 18 is an illustration of a system 1800 including an intake flow path 1810 and an intake heater 1820, according to an embodiment. As shown, the intake heater 1820 includes a mixer 1824, fuel injectors 1828, an electric heater 1851, and a catalyst 1852. In some embodiments, the flow path 1810, the intake heater 1820, and the fuel injector 1828 can be the same or substantially similar to the flow path 910, the intake heater 920, and the fuel injector 928, as described above with reference to FIG. 9. In some embodiments, the mixer 1824 can be the same or substantially similar to the mixer 1724, as described above with reference to FIGS. 17A-17B. Thus, certain aspects of the flow path 1810, the intake heater 1820, the mixer 1824, and the fuel injector 1828 are not described in greater detail herein.

As shown, the system 1800 acts as a catalytic burner that includes the electric heater 1851 upstream of the injection of fuel. The electric heater 1851 raises the charge temperature of the intake gas to a catalyst light-off temperature (e.g., at least about 150° C.). Once this temperature is reached, the fuel injectors 1828 can dose fuel into the intake gas and the mixer 1824 can achieve uniform or near uniform fuel concentration at the front case of the catalyst 1852. The catalyst 1852 enables a surface reaction between the fuel and the intake gas, releasing the heat of combustion of the fuel into the intake flow path 1810. In some embodiments, the catalyst 1852 can be directly electrically heated. This can significantly reduce energy and time required to light off the catalyst 1852, such that the electric heater 1851 can be switched off or removed entirely.

In some embodiments, an engine can employ the strategies described herein in parallel. While independent use of each of these methods is possible, their combination is within the scope of this disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “fuel” can refer to any material capable of producing an exothermic chemical reaction with an intake mixture, regardless of the fuel's cetane number. This can include fuels and blends of: naphtha, gasoline, alcohol fuels (including butanol, propanol, ethanol, and methanol), gaseous hydrocarbons (including natural gas, methane, ethane, propane, butane, hexane, etc.) and alternative fuels such as hydrogen, ammonia, syngas, CO, etc.

As used herein, “plume” can refer to a mass of fuel spreading from an injection point, which may be entraining or mixing with the volume of intake charge as it progresses spatially and/or temporally during a fuel injection event.

As used herein, “intake charge” refers to a volume of material that enters a combustion chamber prior to a combustion event. The intake charge can include air, atmospheric air, humid air, air enriched with oxygen, air diluted with exhaust gas, air diluted with inert gas, fuel, uncombusted fuel, or any combination thereof.

As used herein, “small-molecule fuels” refers to fuels having less than or equal to four carbon atoms per molecule on average (including zero carbon atoms per molecule). This can include hydrogen, ammonia, carbon monoxide (CO), syngas, natural gas, methane, methanol, ethane, ethene, ethanol, di-methyl-ether, propane, propanol, butane, butanol, iso-butanol, and other fuels and fuel blends meeting the criteria of less than or equal to four carbon atoms per molecule on average.

As used herein, “combustion efficiency” can refer to the degree to which air and fuel are fully combusted to form the products of complete combustion. As a non-limiting example, combustion efficiency can be calculated using lower heating value (LHV) of the fuel (e.g., ethanol, methanol, etc.) and combustion products (e.g., CO₂, H₂O, etc.), as set forth below:

$${η}_{combustion} = 1 - \frac{{LHV}_{products} {mass}_{products}}{{LHV}_{fuel} {mass}_{fuel}}$$

Where:
η_{combustion} is the combustion efficiency;
LHV_{products} is the LHV of the combustion products (MJ/kg);
mass_{products} is the mass of the combustion products (kg);
LHV_{fuel} is the LHV of the fuel (MJ/kg); and
mass_{fuel} is the mass of the fuel (kg).

As used herein, “efficiency,” “thermal efficiency,” or “LHV efficiency” can refer to the conversion of fuel energy to mechanical work, calculated as follows:

$$η = \frac{Work}{{LHV}_{fuel} {mass}_{fuel}}$$

Where:
η is the efficiency;
Work is the amount of mechanical work achieved (J), which can be the indicated work calculated from the pressure in the engine cylinder, or the brake work, where the work is measured at the point of the rotating shaft going from the engine into a transmission or generator (i.e., the “brake thermal efficiency);
LHV_{fuel} is the LHV of the fuel (J/kg); and
mass_{fuel} is the mass of the fuel (kg).

As used herein, a numerical definition of a “crank angle” or an “engine crank angle” should be understood as the crank angle relative to a fixed point in the engine cycle (as described below in Table 1 for the case of a four-stroke engine). In other words, in a four-stroke engine, the engine crank angle is 0° (or) 720° when the piston is in the TDC position between the exhaust stroke and the intake stroke. The engine crank angle is 360° when the piston is in the TDC position between the compression stroke and the expansion stroke. The engine crank angle is 540° when the piston is in the BDC position between the expansion stroke and the exhaust stroke. The engine crank angle is 180° when the piston is in the BDC position between the intake stroke and the compression stroke. Negative numbers can also be used to describe the crank angle relative to the TDC position between the exhaust stroke and the intake stroke. In other words, 540° can also be described as −180°, 360° can also be described as −360°, and 180° can also be described as −540°.

TABLE 1
Crank Angle Descriptions for a Four Stroke Engine

| Crank Angle | Piston | |
|---|---|---|
| (Degrees) | Position | Stroke Description |
| 360 (−360) | TDC | Between compression stroke |
| | | and expansion stroke. In |
| | | some literature, this crank |
| | | angle is referred to as |
| | | “TDC Combustion” |
| Between 360 | Transitioning | Expansion stroke |
| and 540 | from TDC | |
| (Between −360 | to BDC | |
| and −180) | | |
| 540 (−180) | BDC | Between expansion stroke |
| | | and exhaust stroke |
| Between 540 | Transitioning | Exhaust stroke |
| and 720 | from BDC | |
| (Between −180 | to TDC | |
| and 0) | | |
| 0 or 720 | TDC | Between exhaust stroke and |
| | | intake stroke. In some |
| | | literature, this crank angle |
| | | is referred to as “TDC gas |
| | | exchange” |
| Between 0 | Transitioning | Intake stroke |
| and 180 | from TDC | |
| (Between −720 | to BDC | |
| and −540) | | |
| 180 (−540) | BDC | Between intake stroke |
| | | and compression stroke |
| Between 180 | Transitioning | Compression stroke |
| and 360 | from BDC | |
| (Between −540 | to TDC | |
| and −360) | | |
| 360 (−360) | TDC | Between compression stroke |
| | | and expansion stroke. In |
| | | some literature, this crank |
| | | angle is referred to as |
| | | “TDC Combustion” |

In some embodiments, the term “immediately prior to ignition” or “just prior to ignition” can refer to a temporal point, at which the engine crank angle is about 300°, about 305°, about 310°, about 315°, about 320°, about 325°, about 330°, about 335°, about 340°, about 345°, about 350°, about 355°, about 360°, about 365°, about 370°, about 375°, or about 380°, inclusive of all values and ranges therebetween.

In some embodiments, the term “immediately prior to ignition” or “just prior to ignition” can refer to a temporal point of approximately 50 ms, approximately 40 ms, approximately 30 ms, approximately 20 ms, approximately 10 ms, approximately 5 ms, approximately 2 ms, or approximately 1 ms prior to ignition, inclusive of all values and ranges therebetween.

In some embodiments, the term “immediately prior to ignition” or “just prior to ignition” can refer to a temporal point preceding the time at which 5% of the fuel exothermicity is observed to have happened. In other words, the fuel can be considered to have ignited when a measurable deviation in pressure could be detected to indicate exothermic fuel oxidation is occurring.

In some embodiments, the term “immediately prior to ignition” or “just prior to ignition” can refer to a temporal point about 1 crank angle degree, about 2 crank angle degrees, about 3 crank angle degrees, about 4 crank angle degrees, about 5 crank angle degrees, about 6 crank angle degrees, about 7 crank angle degrees, about 8 crank angle degrees, about 9 crank angle degrees, about 10 crank angle degrees, about 11 crank angle degrees, about 12 crank angle degrees, about 13 crank angle degrees, about 14 crank angle degrees, about 15 crank angle degrees, about 16 crank angle degrees, about 17 crank angle degrees, about 18 crank angle degrees, about 19 crank angle degrees, or about 20 crank angle degrees prior to ignition, inclusive of all values and ranges therebetween.

In some embodiments, the term “immediately prior to ignition” or “just prior to ignition” can refer to a temporal point about 50 ms, about 40 ms, about 30 ms, about 20 ms, about 10 ms, about 5 ms, about 2 ms, or about 1 ms prior to onset of ignition, inclusive of all values and ranges therebetween.

In some embodiments, the term “immediately prior to fuel injection” or “just prior to fuel injection” can refer to a temporal point about 1 crank angle degree, about 2 crank angle degrees, about 3 crank angle degrees, about 4 crank angle degrees, about 5 crank angle degrees, about 6 crank angle degrees, about 7 crank angle degrees, about 8 crank angle degrees, about 9 crank angle degrees, about 10 crank angle degrees, about 11 crank angle degrees, about 12 crank angle degrees, about 13 crank angle degrees, about 14 crank angle degrees, about 15 crank angle degrees, about 16 crank angle degrees, about 17 crank angle degrees, about 18 crank angle degrees, about 19 crank angle degrees, or about 20 crank angle degrees prior to fuel injection, inclusive of all values and ranges therebetween.

In some embodiments, the term “immediately prior to fuel injection” or “just prior to fuel injection” can refer to a temporal point about 50 ms, about 40 ms, about 30 ms, about 20 ms, about 10 ms, about 5 ms, about 2 ms, or about 1 ms prior to fuel injection, inclusive of all values and ranges therebetween.

In some embodiments, the term “valve closing” (e.g., “intake valve closing” or “exhaust valve closing”) can refer to a temporal point, wherein the valve becomes fully seated (i.e., 0 mm valve lift). In some embodiments, the term “valve opening” (e.g., “intake valve opening” or “exhaust valve opening”) can refer to a temporal point, wherein the valve becomes unseated (i.e., >0 mm lift).

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

In some embodiments, the novel, high-temperature mixing-controlled strategy described herein can be implemented in an opposed piston engine. This could include 2 or more pistons configured to compress an inducted charge, the engine potentially having no cylinder head. This could be a two-four- or other number of stroke design.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method of operating a compression ignition engine, the method comprising:
combusting a first fuel in an intake flow path to heat a volume of air;
drawing the heated volume of air into a plurality of cylinders via an intake manifold; and
combusting a volume of a second fuel in the plurality of cylinders in a mixing-controlled compression ignition mode (MCCI), the second fuel being a small-molecule fuel,
wherein heating the volume of air maintains a temperature in the plurality of cylinders greater than a threshold temperature.

2. The method of claim 1, wherein heating the volume of air includes:
feeding the first fuel from outside the intake flow path to inside the intake flow path via a fuel intake gas mixture flow volume;
transporting the first fuel through a series of perforated baffles inside the fuel intake gas mixture flow volume; and igniting the first fuel via an igniter.

3. The method of claim 1, wherein heating the volume of air includes:
feeding the first fuel from outside the intake flow path to inside the intake flow path via a fuel line;
transporting the first fuel through a series of swirl blades inside the fuel line; and
igniting the first fuel via an igniter.

4. The method of claim 1, wherein heating the volume of air includes:
feeding the first fuel from outside the intake flow path to inside the intake flow path via a combustor;
transporting the first fuel through a perforated burner can; and
igniting the first fuel via an ignitor.

5.-6. (canceled)

7. The method of claim 1, further comprising:
feeding a volume of air from outside the compression ignition engine to the intake flow path to facilitate combustion of the first fuel.

8. The method of claim 1, wherein heating the volume of air includes:
vaporizing the first fuel in a vessel outside of the intake flow path;
after the vaporizing, transporting the first fuel from outside the intake flow path to inside the intake flow path via a fuel line; and
igniting the first fuel upon entering the intake flow path.

9. The method of claim 8, wherein the first fuel is the same fuel as the second fuel.

10. The method of claim 9, wherein the first fuel includes ethanol.

11.-14. (canceled)

15. The method of claim 1, wherein heating the volume of air includes:
feeding the first fuel through a fuel inlet, the fuel inlet including an electrical connection attached thereto;
boiling the first fuel via electrical heating supplied by the electrical connection;
after the boiling, transporting the first fuel from outside the intake flow path to inside the intake flow path via a fuel line; and
transporting the first fuel from inside the fuel line to outside the fuel line and inside the intake flow path via a premixed burner.

16. (canceled)

17. The method of claim 1, further comprising at least one of:
1) bypassing a charge air cooler to increase an average temperature of the volume of air as the volume of air enters the plurality of cylinders;
2) retrieving at least a portion of exhaust gas exiting the plurality of cylinders and recirculating the at least a portion of the exhaust gas back to the plurality of cylinders via a recirculation flow path;
3) heating at least a portion of exhaust gas exiting the plurality of cylinders and recirculating the at least a portion of the exhaust gas back to the plurality of cylinders via a recirculation flow path;
4) retaining at least a portion of exhaust gas in the cylinders;
5) raising an operating temperature of at least a portion of the cylinders by deactivating at least one cylinder;
6) adding load to the cylinders; or
7) applying exhaust braking.

18. The method of claim 1, wherein heating the volume of air includes:
feeding the first fuel from outside the intake flow path to inside the intake flow path via a fuel line; and
igniting the first fuel via a spark plug,
wherein the spark plug is used as a flame ionization sensor to detect flame-out and turn off fuel and re-start.

19. The method of claim 1, wherein heating the volume of air includes:
feeding the first fuel from outside the intake flow path to inside the intake flow path via a fuel line; and
igniting the first fuel via surface ignition.

20. (canceled)

21. The method of claim 1, wherein heating the volume of air includes:
feeding the first fuel from outside the flow path to inside the flow path via a fuel line; and
igniting the first fuel via one or multiple flame plugs.

22.-23. (canceled)

24. A compression ignition engine, comprising:
an intake flow path configured to receive a volume of air;
a plurality of cylinders fluidically coupled to the intake flow path via an intake manifold; and
a fuel-based heating device disposed at least partially in the intake flow path, the fuel-based heating device configured to heat the volume of air in the intake flow path, such that the volume of air maintains a temperature in the plurality of cylinders greater than a threshold temperature.

25. The compression ignition engine of claim 24, wherein the fuel-based heating device includes a fuel line that extends from a first location outside the intake flow path and a terminal end inside the intake flow path, the fuel-based heating device further including an igniter configured to ignite a first fuel flowing through the fuel line, such that a burner warms the volume of air.

26.-29. (canceled)

30. The compression ignition engine of claim 25, wherein the fuel-based heating device includes a plurality of fuel feeding units disposed in a wall of the intake flow path, the plurality of fuel feeding units configured to transport fuel to contact the igniter, the compression ignition engine further comprising:
a flame protector disposed in the intake flow path and attached to an interior wall of the intake flow path, the flame protector configured to block and re-route the flow of the volume of air such that the volume of air does not disturb ignition of the first fuel via the igniter.

31. The compression ignition engine of claim 25, wherein the fuel line includes an injector mounted to and penetrating a wall of the intake flow path.

32. The compression ignition engine of claim 25, wherein the fuel-based heating device includes a boiler fluidically coupled to the fuel line, the boiler configured to boil a liquid fuel, such that the liquid fuel becomes a gaseous fuel and flows through the fuel line and into the intake flow path.

33. The compression ignition engine of claim 32, wherein the boiler includes a level sensor, the compression ignition engine further comprising a fuel tank and a pump, the pump in communication with the level sensor, the pump configured to deliver fuel to the boiler based on data communicated from the level sensor to the pump.

34. (canceled)

35. The compression ignition engine of claim 32, wherein the boiler includes a temperature sensor and an electric heater in communication with the temperature sensor, the electric heater configured to switch on based on temperature data communicated by the temperature sensor.

36.-42. (canceled)
